(19) United States
(12) Patent Application Publication
(10) Pub. No.: US 2025/0253916 A1
(43) Pub. Date: Aug. 7, 2025

(54) REFERENCE SIGNAL RESOURCE SELECTION BASED BEAM PREDICTION

(71) Applicant: QUALCOMM INCORPORATED, San Diego, CA (US)

(72) Inventors: Qiaoyu Li, Beijing (CN); Tao Luo, San Diego, CA (US); Mahmoud Taherzadeh Boroujeni, San Diego, CA (US); Junyi Li, Greentown, PA (US)

(21) Appl. No.: 18/855,860

(22) PCT Filed: Jul. 6, 2022
(86) PCT No.: PCT/CN2022/104044

§ 371 Date: Oct. 10, 2024

(51) Int. Cl. H04B 7/06; H04L 5/00; H04L 12/43; H04W 24/02

(52) U.S. Cl. CPC H04B 7/06952; H04B 7/0697; H04L 5/0044; H04L 12/43; H04W 24/02

(57) ABSTRACT

Methods, systems, and devices for wireless communications are described. A user equipment (UE) may receive a message indicating a reference signal resource set that includes a set of reference signal resources associated with a time division multiplexing (TDM) scheme and a set of spatial precoders. A network entity may use a codebook or an artificial intelligence (AI) model to determine the SRI. The UE may transmit reference signals using the reference signal resources and according to the TDM scheme and using the spatial precoders. The UE may receive a message including a sounding reference signal (SRS) resource indicator (SRI) indicating at least two reference signal resources, which may correspond to a set of beams predicted by the network entity. The SRI may include a linear combination of the reference signal resources. The UE may transmit an uplink message using an uplink transmission beam based on the set of beams.

### CROSS REFERENCE

The present Application is a 371 national stage filing of International PCT Application No. PCT/CN2022/104044 by Li et al. entitled “REFERENCE SIGNAL RESOURCE SELECTION BASED BEAM PREDICTION,” filed Jul. 6, 2022, which is assigned to the assignee hereof, and which is expressly incorporated by reference in its entirety herein.

### TECHNICAL FIELD

The following relates to wireless communications, and more specifically reference signal resource selection based beam prediction.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support reference signal resource selection-based beam predictions. In some examples, a user equipment (UE) may receive a configuration message from a network entity that configures a sounding reference signal (SRS) resource set, which may correspond to a set of reference signal beams. The network entity may use a codebook or an artificial intelligence (AI) model to define the SRS resource set, which may be a portion of total SRS resources available for the UE. The UE may transmit multiple reference signals using the SRS resources indicated in the SRS resource set and in accordance with a time division multiplexing (TDM) scheme and a set of time-varying spatial precoders. In some examples, the UE may receive an SRS resource indicator (SRI) from the network entity, which indicates two or more SRS resources from the SRS resource set. The SRI may indicate a linear combination of the two or more SRS resources from the SRS resource set, where the two or more SRS resources may be from one or more previous SRS transmission occasions or one or more most recent SRS transmission occasions. The UE may transmit an uplink transmission to the network entity using an uplink beam determined based on the one or more SRS resources indicated in the SRI (e.g., based on the linear combination).

A method for wireless communication at a UE is described. The method may include receiving a first message indicating a reference signal resource set including a set of multiple reference signal resources associated with a TDM scheme, transmitting a set of multiple reference signals using the set of multiple reference signal resources according to the TDM scheme, receiving a second message including a reference signal resource indicator indicating two or more reference signal resources of the set of multiple reference signal resources, and transmitting a first uplink message using a first uplink transmission beam, the first uplink transmission beam based on a set of beams that correspond to the two or more reference signal resources.

An apparatus for wireless communication at a UE is described. The apparatus may include at least one processor, and memory coupled with the at least one processor, the memory storing instructions executable by the at least one processor to cause the UE to receive a first message indicating a reference signal resource set including a set of multiple reference signal resources associated with a TDM scheme, transmit a set of multiple reference signals using the set of multiple reference signal resources according to the TDM scheme, receive a second message including a reference signal resource indicator indicating two or more reference signal resources of the set of multiple reference signal resources, and transmit a first uplink message using a first uplink transmission beam, the first uplink transmission beam based on a set of beams that correspond to the two or more reference signal resources.

Another apparatus for wireless communication at a UE is described. The apparatus may include means for receiving a first message indicating a reference signal resource set including a set of multiple reference signal resources associated with a TDM scheme, means for transmitting a set of multiple reference signals using the set of multiple reference signal resources according to the TDM scheme, means for receiving a second message including a reference signal resource indicator indicating two or more reference signal resources of the set of multiple reference signal resources, and means for transmitting a first uplink message using a first uplink transmission beam, the first uplink transmission beam based on a set of beams that correspond to the two or more reference signal resources.

A non-transitory computer-readable medium storing code for wireless communication by a UE is described. The code may include instructions executable by the at least one processor to receive a first message indicating a reference signal resource set including a set of multiple reference signal resources associated with a TDM scheme, transmit a set of multiple reference signals using the set of multiple reference signal resources according to the TDM scheme, receive a second message including a reference signal resource indicator indicating two or more reference signal resources of the set of multiple reference signal resources, and transmit a first uplink message using a first uplink transmission beam, the first uplink transmission beam based on a set of beams that correspond to the two or more reference signal resources.

Some examples of the method, apparatuses, and non-transitory computer-readable medium described herein may further include operations, features, means, or instructions for receiving a third message including a second reference signal resource indicator indicating at least one of the two or more reference signal resources and a third reference signal resource of the set of multiple reference signal resources and transmitting a second uplink message using a second uplink transmission beam, the second uplink transmission beam based on a second set of beams that correspond to the at least one of the two or more reference signal resources and the third reference signal resource.

In some examples of the method, apparatuses, and non-transitory computer-readable medium described herein, transmitting the set of multiple reference signals may include operations, features, means, or instructions for transmitting the set of multiple reference signals using the set of multiple reference signal resources according to the TDM scheme and a set of multiple time-varying spatial precoders associated with the set of multiple reference signal resources.

In some examples of the method, apparatuses, and non-transitory computer-readable medium described herein, the set of multiple time-varying spatial precoders may be different for different transmission occasions of the set of multiple reference signals and the set of multiple reference signals may be transmitted according to a periodicity or semi-persistently.

In some examples of the method, apparatuses, and non-transitory computer-readable medium described herein, receiving the first message may include operations, features, means, or instructions for receiving the first message indicating codebook identifying a set of multiple time-varying spatial precoders associated with the set of multiple reference signal resources of the reference signal resource set.

In some examples of the method, apparatuses, and non-transitory computer-readable medium described herein, the codebook may be time-variant based on an indication from a network entity or the UE.

In some examples of the method, apparatuses, and non-transitory computer-readable medium described herein, receiving the first message may include operations, features, means, or instructions for receiving the first message indicating an output of a machine learning model identifying a set of multiple time-varying spatial precoders associated with the set of multiple reference signal resources of the reference signal resource set.

In some examples of the method, apparatuses, and non-transitory computer-readable medium described herein, the machine learning model may be time-variant based on an indication from a network entity or the UE.

In some examples of the method, apparatuses, and non-transitory computer-readable medium described herein, receiving the second message may include operations, features, means, or instructions for receiving the second message including the reference signal resource indicator indicating a linear combination of the two or more reference signal resources of the set of multiple reference signal resources, where the two or more reference signal resources may be associated with one or more transmission occasions.

In some examples of the method, apparatuses, and non-transitory computer-readable medium described herein, transmitting the first uplink message may include operations, features, means, or instructions for transmitting the first uplink message based on a spatial precoder associated with the linear combination of the two or more reference signal resources.

In some examples of the method, apparatuses, and non-transitory computer-readable medium described herein, transmitting the first uplink message may include operations, features, means, or instructions for transmitting the first uplink message based on a spatial precoder output by a machine learning model, where the machine learning model uses at least the reference signal resource indicator as an input.

In some examples of the method, apparatuses, and non-transitory computer-readable medium described herein, receiving the second message may include operations, features, means, or instructions for receiving the second message including the reference signal resource indicator indicating the two or more reference signal resources and including a rank of the reference signal resource indicator.

In some examples of the method, apparatuses, and non-transitory computer-readable medium described herein, transmitting the first uplink message may include operations, features, means, or instructions for transmitting the first uplink message based on a spatial precoder associated with the rank of the reference signal resource indicator, where the spatial precoder may be used with different reference signal ports.

In some examples of the method, apparatuses, and non-transitory computer-readable medium described herein, receiving the first message may include operations, features, means, or instructions for receiving the first message indicating a usage type associated with the reference signal resource set including the set of multiple reference signal resources.

In some examples of the method, apparatuses, and non-transitory computer-readable medium described herein, receiving the second message may include operations, features, means, or instructions for receiving the second message including the reference signal resource indicator, where the second message configures an uplink transmission configuration indicator state for the UE.

A method for wireless communication at a network entity is described. The method may include transmitting a first message indicating a reference signal resource set including a set of multiple reference signal resources associated with a TDM scheme, receiving a set of multiple reference signals using the set of multiple reference signal resources according to the TDM scheme, transmitting a second message including a reference signal resource indicator indicating two or more reference signal resources of the set of multiple reference signal resources, and receiving a first uplink message using a first uplink transmission beam, the first uplink transmission beam based on a set of beams that correspond to the two or more reference signal resources.

An apparatus for wireless communication at a network entity is described. The apparatus may include at least one processor, and memory coupled with the at least one processor, the memory storing instructions executable by the at least one processor to cause the network entity to transmit a first message indicating a reference signal resource set including a set of multiple reference signal resources associated with a TDM scheme, receive a set of multiple reference signals using the set of multiple reference signal resources according to the TDM scheme, transmit a second message including a reference signal resource indicator indicating two or more reference signal resources of the set of multiple reference signal resources, and receive a first uplink message using a first uplink transmission beam, the first uplink transmission beam based on a set of beams that correspond to the two or more reference signal resources.

Another apparatus for wireless communication at a network entity is described. The apparatus may include means for transmitting a first message indicating a reference signal resource set including a set of multiple reference signal resources associated with a TDM scheme, means for receiving a set of multiple reference signals using the set of multiple reference signal resources according to the TDM scheme, means for transmitting a second message including a reference signal resource indicator indicating two or more reference signal resources of the set of multiple reference signal resources, and means for receiving a first uplink message using a first uplink transmission beam, the first uplink transmission beam based on a set of beams that correspond to the two or more reference signal resources.

A non-transitory computer-readable medium storing code for wireless communication at a network entity is described. The code may include instructions executable by at least one processor to transmit a first message indicating a reference signal resource set including a set of multiple reference signal resources associated with a TDM scheme, receive a set of multiple reference signals using the set of multiple reference signal resources according to the TDM scheme, transmit a second message including a reference signal resource indicator indicating two or more reference signal resources of the set of multiple reference signal resources, and receive a first uplink message using a first uplink transmission beam, the first uplink transmission beam based on a set of beams that correspond to the two or more reference signal resources.

Some examples of the method, apparatuses, and non-transitory computer-readable medium described herein may further include operations, features, means, or instructions for transmitting a third message including a second reference signal resource indicator indicating at least one of the two or more reference signal resources and a third reference signal resource of the set of multiple reference signal resources and receiving a second uplink message using a second uplink transmission beam, the second uplink transmission beam based on a second set of beams that correspond to the at least one of the two or more reference signal resources and the third reference signal resource.

In some examples of the method, apparatuses, and non-transitory computer-readable medium described herein, receiving the set of multiple reference signals may include operations, features, means, or instructions for receiving the set of multiple reference signals using the set of multiple reference signal resources according to the TDM scheme and a set of multiple time-varying spatial precoders associated with the set of multiple reference signal resources.

In some examples of the method, apparatuses, and non-transitory computer-readable medium described herein, the set of multiple time-varying spatial precoders may be different for different transmission occasions of the set of multiple reference signals, where the set of multiple reference signals may be transmitted according to a periodicity or semi-persistently.

In some examples of the method, apparatuses, and non-transitory computer-readable medium described herein, transmitting the first message may include operations, features, means, or instructions for transmitting the first message indicating codebook identifying a set of multiple time-varying spatial precoders associated with the set of multiple reference signal resources of the reference signal resource set.

In some examples of the method, apparatuses, and non-transitory computer-readable medium described herein, codebook may be time-variant based on an indication from the network entity or a UE.

In some examples of the method, apparatuses, and non-transitory computer-readable medium described herein, transmitting the first message may include operations, features, means, or instructions for transmitting the first message indicating an output of a machine learning model identifying a set of multiple time-varying spatial precoders associated with the set of multiple reference signal resources of the reference signal resource set.

In some examples of the method, apparatuses, and non-transitory computer-readable medium described herein, the machine learning model may be time-variant based on an indication from the network entity or a UE.

In some examples of the method, apparatuses, and non-transitory computer-readable medium described herein, transmitting the second message may include operations, features, means, or instructions for transmitting the second message including the reference signal resource indicator indicating a linear combination of the two or more reference signal resources of the set of multiple reference signal resources, where the two or more reference signal resources may be associated with one or more transmission occasions.

In some examples of the method, apparatuses, and non-transitory computer-readable medium described herein, transmitting the second message may include operations, features, means, or instructions for transmitting the second message including the reference signal resource indicator indicating the two or more reference signal resources and including a rank of the reference signal resource indicator.

In some examples of the method, apparatuses, and non-transitory computer-readable medium described herein, transmitting the first message may include operations, features, means, or instructions for transmitting the first message indicating a usage type associated with the reference signal resource set including the set of multiple reference signal resources.

In some examples of the method, apparatuses, and non-transitory computer-readable medium described herein, transmitting the second message may include operations, features, means, or instructions for transmitting the second message including the reference signal resource indicator, where the second message configures an uplink transmission configuration indicator state for a UE.

### BRIEF DESCRIPTION OF THE DRAWINGS

FIG. 1 illustrates an example of a wireless communications system that supports reference signal resource selection based beam prediction in accordance with one or more aspects of the present disclosure.

FIG. 2 illustrates an example of a process flow that supports reference signal resource selection based beam prediction in accordance with one or more aspects of the present disclosure.

FIG. 3 illustrates an example of a beam-sweep timeline for a user equipment (UE) that supports reference signal resource selection based beam prediction in accordance with one or more aspects of the present disclosure.

FIG. 4 illustrates an example of a process flow that supports reference signal resource selection based beam prediction in accordance with one or more aspects of the present disclosure.

FIG. 5 illustrates an example of a sounding reference signal (SRS) resource indicator (SRI) mapping scheme that supports reference signal resource selection based beam prediction in accordance with one or more aspects of the present disclosure.

FIG. 6 illustrates an example of a process flow that supports reference signal resource selection based beam prediction in accordance with one or more aspects of the present disclosure.

FIGS. 7 and 8 show block diagrams of devices that support reference signal resource selection based beam prediction in accordance with one or more aspects of the present disclosure.

FIG. 9 shows a block diagram of a communications manager that supports reference signal resource selection based beam prediction in accordance with one or more aspects of the present disclosure.

FIG. 10 shows a diagram of a system including a device that supports reference signal resource selection based beam prediction in accordance with one or more aspects of the present disclosure.

FIGS. 11 and 12 show block diagrams of devices that support reference signal resource selection based beam prediction in accordance with one or more aspects of the present disclosure.

FIG. 13 shows a block diagram of a communications manager that supports reference signal resource selection based beam prediction in accordance with one or more aspects of the present disclosure.

FIG. 14 shows a diagram of a system including a device that supports reference signal resource selection based beam prediction in accordance with one or more aspects of the present disclosure.

FIGS. 15 through 21 show flowcharts illustrating methods that support reference signal resource selection based beam prediction in accordance with one or more aspects of the present disclosure.

### DETAILED DESCRIPTION

In some examples, a user equipment (UE) may use beam sweeping to determine receive beams and transmit beams that may be used for communications between a network entity and the UE. For example, a UE may perform beam sweeping over a set of beams by transmitting one or more reference signals using the set of beams, which may be used by the network entity and the UE to determine which transmit beam (or linear combination of beams) to use for uplink transmissions from the UE to the network entity. The selected transmit beam may correspond to a reference signal received power (RSRP), or other channel metric associated with the set of beams, satisfying a threshold. In some cases, the network entity may use a sounding reference signal (SRS) resource indicator (SRI), which may indicate one or more SRS resources that correspond to one or more beams that the UE may use to communicate uplink transmissions with the network entity. However, beam sweeping across a set of beams may be power and resource intensive for the UE, which may increase as the quantity of beams included in the set of beams increases. Additionally, the SRI transmitted by the network entity to the UE may be designed to only support the indication of a single beam based on the most recent measurements obtained by the network entity, which may limit flexibility.

Techniques described herein support reference signal resource selection-based beam predictions. In some examples, a UE may receive a configuration message from a network entity that configures an SRS resource set corresponding to a set of reference signal beams or uplink transmit beams for the UE. The network entity may use a codebook or an output of an artificial intelligence (AI) model to indicate the SRS resource set, which may include a portion of the total SRS resources available for the UE. The UE may transmit one or more reference signals using the SRS resources indicated in the SRS resource set in accordance with a time division multiplexing (TDM) scheme and using a set of time-varying spatial precoders. In some examples, the UE may receive an SRI from the network entity, which may indicate two or more SRS resources from the SRS resource set. For instance, the SRI may indicate a linear combination of the two or more SRS resources from the SRS resource set. In some cases, the two or more SRS resources may include SRS resources of one or more previous SRS transmission occasions or one or more most recent SRS transmission occasions, or both. The UE may transmit an uplink transmission to the network entity using an uplink beam determined based on the one or more SRS resources indicated in the SRI. That is, the network entity, the UE, or both may use beam prediction techniques to determine the uplink beam used by the UE for transmitting uplink messages to the network entity.

Aspects of the subject matter described herein may be implemented to realize one or more of the following potential improvements, among others. The techniques employed by the described network devices (e.g., UEs, network entities) may enable a UE to transmit reference signals to a network entity using one or more reference signal resources indicated by the network entity by reducing overhead, which may improve efficiency of the transmissions. In addition, the described techniques may enable the network entity to transmit an SRI indicating two or more reference signal resources the UE may use to transmit an uplink message, and the SRI may be determined based on a codebook or an AI model. Using a codebook or an AI model may reduce overhead and power consumption at the UE and improve communications between the UE and the network entity, among other benefits.

Aspects of the disclosure are initially described in the context of wireless communications systems. Aspects of the disclosure are then described in the context of process flows. Aspects of the disclosure are further illustrated by and described with reference to apparatus diagrams, system diagrams, and flowcharts that relate to reference signal resource selection based beam prediction.

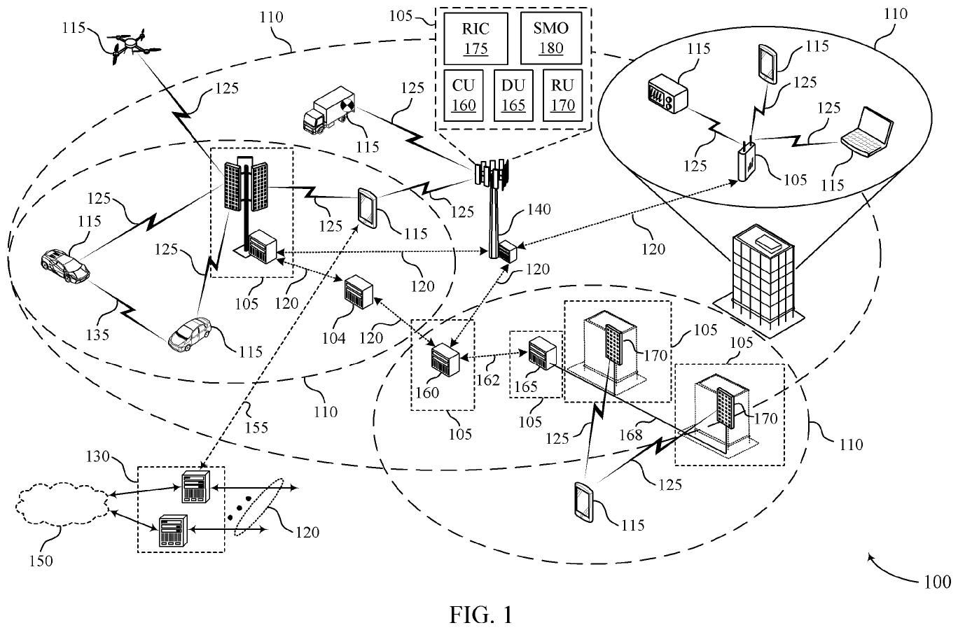

FIG. 1 illustrates an example of a wireless communications system 100 that supports reference signal resource selection based beam prediction in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending upon which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support reference signal resource selection based beam prediction as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

Some UEs 115, such as MTC or IoT devices, may be low cost or low complexity devices, and may provide for automated communication between machines (e.g., via Machine-to-Machine (M2M) communication). M2M communication or MTC may refer to data communication technologies that allow devices to communicate with one another or a network entity 105 without human intervention. In some examples, M2M communication or MTC may include communications from devices that integrate sensors or meters to measure or capture information and relay that information to a central server or application program that can make use of the information or present the information to humans interacting with the program or application. Some UEs 115 may be designed to collect information or enable automated behavior of machines. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging. In an aspect, techniques disclosed herein may be applicable to MTC or IoT UEs. MTC or IoT UEs may include MTC/enhanced MTC (eMTC, also referred to as CAT-M, Cat M1) UEs, NB-IoT (also referred to as CAT NB1) UEs, as well as other types of UEs. eMTC and NB-IoT may refer to future technologies that may evolve from or may be based on these technologies. For example, eMTC may include FeMTC (further eMTC), eFeMTC (enhanced further eMTC), and mMTC (massive MTC), and NB-IoT may include eNB-IoT (enhanced NB-IoT), and FeNB-IoT (further enhanced NB-IoT).

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a wireless local area network (WLAN), such as a Wi-Fi (e.g., Institute of Electrical and Electronics Engineers (IEEE) 802.11) network may include an access point (AP) that may communicate with one or more wireless or mobile devices. The AP may be coupled to a network, such as the Internet, and may enable a mobile device to communicate via the network (or communicate with other devices coupled to the access point). A wireless device may communicate with a network device bi-directionally. For example, in a WLAN, a device may communicate with an associated AP via downlink (e.g., the communication link from the AP to the device) and uplink (e.g., the communication link from the device to the AP). A wireless personal area network (PAN), which may include a Bluetooth connection, may provide for short range wireless connections between two or more paired wireless devices. For example, wireless devices such as cellular phones may utilize wireless PAN communications to exchange information such as audio signals with wireless headsets. Components within a wireless communications system may be coupled (for example, operatively, communicatively, functionally, electronically, and/or electrically) to each other.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of TDM techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

A network entity 105 may use beam sweeping to determine an uplink transmit beam of a UE 115. In some examples, the network entity 105 may perform beam sweeping across multiple SRS resources associated with the UE 115 (e.g., across each SRS resource in an SRS resource set). For example, for one receive antenna panel of the network entity 105 with 32 receive beams and two polarizations (e.g., 64 receive beams) and two transmit antenna panels (e.g., non-simultaneous) of the UE 115 with four receive beams per panel and two polarizations (e.g., 16 transmit beams), there may be 1024 beam pairs (e.g., 64 receive beams times 16 transmit beams) that may be tested using SRS-based beam sweeping. Because of the large quantity of beam pairs, beam sweeping across all the beam pairs may be power intensive and consume overhead resources, including time and frequency, at the UE 115. In some examples, the network entity 105 may indicate an SRI to the UE 115 before scheduling a physical uplink shared channel (PUSCH). The network entity 105 may transmit the SRI in an uplink grant, such as within downlink control information (DCI). The SRI may indicate one or more SRS resources that correspond to one or more transmit beams that the UE 115 may use for transmitting the PUSCH to the network entity 105. However, as the quantity of transmit beams at the UE increases and the quantity of receive beams at the network entity increases, beam sweeping using the SRS in this manner may increase power consumption and overhead at the UE 115.

The wireless communications system 100 supports reference signal resource selection-based beam predictions. In some examples, a UE 115 may receive a configuration message from a network entity 105 that configures an SRS resource set corresponding to a set of reference signal beams (e.g., uplink transmit beams for the UE 115). The network entity 105 may use a codebook or an AI model to indicate the SRS resource set, and the SRS resource set indicated by the network entity 105 may be a portion of the total SRS resources available for the UE 115. The UE 115 may transmit one or more reference signals (e.g., SRSs) using the SRS resources indicated in the SRS resource set according to a TDM scheme and using a set of time-varying spatial precoders, where a given spatial precoder corresponds to a respective uplink transmit beam for the UE 115. In some examples, the UE 115 may receive an SRI from the network entity 105, and the SRI may indicate two or more SRS resources from the SRS resource set. For instance, the SRI may indicate a linear combination of the two or more SRS resources from the SRS resource set. In some cases, the two or more SRS resources may include SRS resources of one or more most recent SRS transmission occasions, one or more previous SRS transmission occasions, or both. The UE 115 may transmit an uplink transmission to the network entity 105 using an uplink beam determined based on the one or more SRS resources indicated in the SRI. That is, the network entity 105, the UE 115, or both may use beam prediction techniques to determine the uplink beam used by the UE 115 for transmitting uplink messages to the network entity.

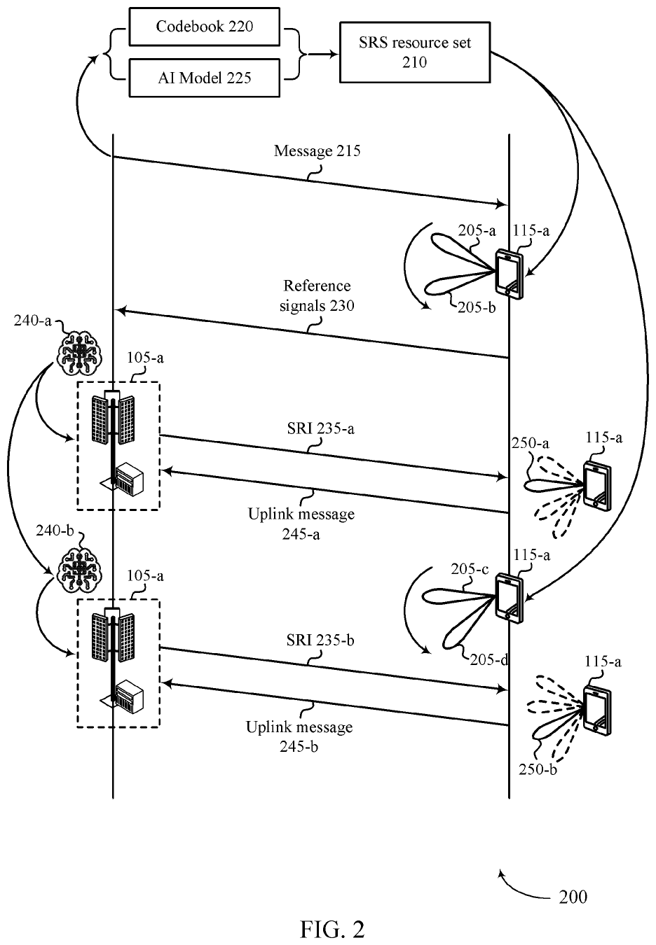

FIG. 2 illustrates an example of a process flow 200 that supports reference signal resource selection based beam prediction in accordance with one or more aspects of the present disclosure. In some examples, the process flow 200 may implement aspects of the wireless communications system 100 or may be implemented by aspects of the wireless communications system 100. For example, the process flow 200 may include a UE 115-a and a network entity 105-a, which may be examples of corresponding devices described herein. In some examples, the UE 115-a and the network entity 105-a may use time domain beam sweeping to increase beam sweeping efficiency, decrease system overhead, and decrease power consumption in a wireless communications system, among other benefits.

The process flow 200 may support communications between the network entity 105-a and the UE 115-a. For example, the network entity 105-a may communicate signals (e.g., uplink and downlink transmissions) with the UE 115-a over respective communication links. In some examples, the UE 115-a may support a quantity of SRS resources 205, which may be associated with transmit beams or receive beams. Some SRS resources 205 may be included in an SRS resource set 210.

To support SRS resource selection based beam predictions by the network entity 105-a, the network entity 105-a may transmit a message 215 to the UE 115-a indicating the SRS resource set 210, where the SRS resource set 210 may include a set of SRS resources 205 corresponding to one or more transmit beams of the UE 115-a and may be associated with a TDM scheme. For example, the SRS resource set 210 may include an SRS resource 205-a corresponding to a first transmit beam and an SRS resource 205-b corresponding to a second transmit beam, where SRS resource 205-a and SRS resource 205-b are TDMed (e.g., do not overlap in time). In some examples, the SRS resource 205-a and the SRS resource 205-b included in the SRS resource set 210 may be associated with a set of time-varying spatial precoders such that a respective spatial precoder of the set of time-varying spatial precoders corresponds to a respective transmit beam of the UE 115-a. In some cases, the network entity 105-a may indicate via the message 215 whether the SRS resources 205 are periodic, or the network entity 105-a may activate or schedule the SRS resource set 210 for the UE 115-a via the message 215 if the SRS resources 205 are semi-persistent or aperiodic.

The network entity 105-a may use a codebook 220 or an output of an AI model 225 to define the SRS resource set 210. For example, the network entity 105-a may transmit the message 215 to the UE 115-a, where the message 215 may indicate a codebook 220 that identifies a set of time-varying spatial precoders corresponding to respective transmit beams of the UE 115-a. That is, the codebook 220 may specify the set of time-varying spatial precoders (e.g., spatial precoding coefficients) associated with a respective SRS resource 205 during a particular SRS transmission occasion. In some examples, the network entity 105-a may pre-configure or dynamically update the SRS resource set 210 defined by the codebook 220. Alternatively, the codebook-based SRS resource set 210 may be reported by the UE 115-a. For example, the UE 115-a may report the codebook 220 back to the network entity 105-a, where the codebook 220 may specify which time-varying spatial precoders may be used for respective transmit beams of the UE 115-a. In addition, the time-varying spatial precoders associated with the SRS resources 205 of the SRS resource set 210, defined based on the codebook 220, may be associated with different phase shifters of the UE 115-a or different beams of the UE 115-a.

Alternatively, the network entity 105-a may use the AI model 225 to define the SRS resource set 210. The AI model 225 may be a machine learning model or an analytical model. The network entity 105-a may transmit the message 215 to the UE 115-a, where the message 215 may indicate an output of the AI model 225 that identifies the set of time-varying spatial precoders corresponding to respective transmit beams of the UE 115-a. In some examples, inputs to the AI model 225 may include CSI-RS tones configured as an associatedCSI-RS parameter with respect to the AI model-defined SRS resource set 210 (e.g., SRS-ResourceSet), a channel estimated from the CSI-RS, or both. That is, the UE 115-a may receive a downlink reference signal (e.g., the CSI-RS), and the UE 115-a may use some spatial filters for the transmission that matches the received downlink reference signal as closely as possible.

Additionally, or alternatively, the inputs to the AI model 225 may include one or more parameters configured or indicated by the network entity 105-a, such as one or more bits derived from a channel estimated from a previously received SRS, a most recently received SRS, or both. The output of the AI model 225 may specify the set of time-varying spatial precoders (e.g., spatial precoding coefficients) associated with an SRS resource 205 during a particular SRS transmission occasion. In some examples, the network entity 105-a may pre-configure or dynamically update the SRS resource set 210 defined by the AI model 225. For example, the network entity 105-a may configure the AI model 225 using inputs provided by the network entity 105-a, the UE 115-a, or both, and the AI model 225 may output the various time-varying spatial precoders that may be used for given SRS resources 205. Alternatively, the AI model-based SRS resource set 210 may be reported by the UE 115-a. In addition, the time-varying spatial precoders associated with the SRS resources 205 of the SRS resource set 210, defined based on the AI model 225, may be associated with different phase shifters or different beams (e.g., transmit beams, uplink beams) of the UE 115-a.

In some examples, the codebook 220, the AI model 225, or both may be time-varying based on an indication from the network entity 105-a or the UE 115-a. For example, for periodic and semi-persistent SRS transmissions, the time-varying spatial precoders used for the same SRS resource 305 over different SRS transmission occasions may be different. For the codebook 220, the different time-varying spatial precoders used over different SRS transmission occasions may be defined based on SRS resources 205 used for a particular SRS transmission occasion that are defined in the codebook 220. For example, SRS resources #0, #1, and #2 transmitted during an SRS transmission occasion #0 may use a spatial precoder #0, #1, and #2 that are defined in the codebook 220, SRS resources #0, #1, and #2 transmitted during an SRS transmission occasion #1 may use a spatial precoder #3, #4, and #5 that are defined in the codebook 220, SRS resources #0, #1, and #2 transmitted during the SRS transmission occasion #0 may use a spatial precoder #0, #2, and #4 that are defined in the codebook 220, and SRS resources #0, #1, and #2 transmitted during the SRS transmission occasion #1 may use a spatial precoder #1, #3, and #5 that are defined in the codebook 220. For the AI model 225, the different time-varying spatial precoders used over different SRS transmission occasions may be determined by the one or more inputs to the AI model 225, as the AI model 225 may output different time-varying spatial precoders associated with different SRS transmission occasions.

In some cases, the network entity 105-a may use configure the codebook 220 and the AI model 225 to be time-variant for interference avoidance. That is, the codebook 220, the AI model 225, one or more inputs to the AI model 225, or any combination thereof may be time-variant to avoid inter-cell and inter-UE interference in dynamic TDD or full-duplex operations. For example, the network entity 105-a may use a first codebook, a first AI model, a first input for the first AI model, or any combination thereof for an SRS resource set 210 in a first SRS transmission occasion, and a second codebook, a second AI model, a second input for the second AI model, or any combination thereof for an SRS resource set 210 in a second SRS transmission occasion. In some cases, the first and second codebooks may specify different phase shifts, the first and second AI models may specify different neuron coefficients (e.g., used in a neural network of the first and second AI models), the first and second inputs may include different filters on one or more CSI-RSs associated with the SRS resource set 210, or any combination thereof.

In some examples, the network entity 105-a may RRC configure or dynamically indicate, via a MAC control element (MAC-CE) or DCI, the time-variant behavior of the codebook 220, the AI model 225, the inputs to the AI model 225, or any combination thereof. The network entity 105-a may transmit a dynamic indication via a MAC-CE or DCI based on re-triggering (e.g., re-activating) an SRS transmission with updated parameters. Alternatively, the UE 115-a may report the time-variant behavior of the codebook 220, the AI model 225, the inputs to the AI model 225, or any combination thereof. For example, the UE 115-a may use a MAC-CE or uplink control information (UCI) to report a recently used spatial precoder that may be different from a spatial precoder based on the codebook 220 or AI model 225 as configured by the network entity 105-a. In some examples, the UE 115-a may report the time-variant behavior in cases which the UE 115-a may be more familiar with interference scenarios in a wireless communications system, and because the network entity 105-a may more effectively facilitate beam predictions if the time-variant behavior is known.

During a first SRS transmission occasion, the UE 115-a may transmit a set of reference signals 230 to the network entity 105-a using the SRS resources 205 in the SRS resource set 210 (e.g., the SRS resource 205-a and the SRS resource 205-b) according to the TDM scheme. In some examples, the UE 115-a may transmit the set of reference signals 230 according to the set of time-varying spatial precoders associated with the SRS resources 205 in addition to the TDM scheme. Alternatively, if the set of time-varying spatial precoders are different for different SRS transmission occasions, the UE 115-a may transmit the set of reference signals 230 according to a periodicity (e.g., periodically) or semi-persistently.

The UE 115-a may receive a second message from the network entity 105-a indicating an SRI 235-a, the SRI 235-a indicating two or more SRS resources 205 of the set of SRS resources 205 included in the SRS resource set 210. For example, if the SRS resource set 210 includes the SRS resource 205-a, the SRS resource 205-b, and one or more additional SRS resources 205, the SRI 235-a may indicate the SRS resource 205-a and the SRS resource 205-b. That is, the SRI 235-a may indicate one or more SRS resources 205 that correspond to one or more beams that the UE 115-a may use to communicate uplink transmissions with the network entity 105-a. In some examples, the network entity 105-a may configure the SRI 235-a for a configured grant PUSCH, or the network entity 105-a may indicate the SRI 235-a for a dynamically scheduled PUSCH.

In some examples, the network entity 105-a may use a model 240-a (e.g., a machine learning model, an AI model) to predict a set of beams prior to generating the SRI 235-a. That is, based on receiving the set of reference signals 230 via the SRS resources 205 indicated in the SRS resource set 210 and during the first SRS transmission occasion, the network entity 105-a may use the model 240-a to predict a set of beams the UE 115-a may use to most efficiently perform uplink transmissions. In response to receiving the second message including the SRI 235-a, the UE 115-a may transmit a first uplink message 245-a (e.g., a PUSCH) using a first uplink transmission beam 250-a, the first uplink transmission beam 250-a based on the set of beams that correspond to the two or more SRS resources 205 (e.g., the SRS resource 205-a and the SRS resource 205-b) indicated in the SRI 235-a (e.g., the predicted set of beams).

In some cases, during a second SRS transmission occasion, the SRS resource set 210 may include the SRS resource 205-a, the SRS resource 205-b, an SRS resource 205-c, and an SRS resource 205-d, where the SRS resource 205-c and the SRS resource 205-d may correspond to different time-varying spatial precoders than the SRS resource 205-a and the SRS resource 205-b. That is, the same SRS resource 205 may change its spatial precoding direction. During the second SRS transmission occasion, the UE 115-a may transmit a set of reference signals to the network entity 105-a using some SRS resources 205 in the SRS resource set 210 (e.g., the SRS resource 205-c and the SRS resource 205-d) according to the TDM scheme.

In some examples, the UE 115-a may interpret an SRI 235 as a linear combination of the SRS resources 205 included in the SRS resource set 210 over one or multiple previous (e.g., historical) SRS transmission occasions, one or more most recent SRS transmission occasions, or both. For example, the UE 115-a may receive a third message indicating an SRI 235-b, the SRI 235-b indicating at least one of the two or more SRS resources 205 from the SRS resource set 210 (as indicated in the message 215) and a third SRS resource 205, which may be the SRS resource 205-c or the SRS resource 205-d. For example, the SRI 235-b may indicate the SRS resource 205-a, the SRS resource 205-b, and the SRS resource 205-c, where the SRS resource 205-a and the SRS resource 205-b are from a previous SRS transmission occasion (e.g., the first SRS transmission occasion). The SRS resource 205-a, the SRS resource 205-b, and the SRS resource 205-c may be indicated in the SRI 235-b as a linear combination of SRS resources 205 within the SRS resource set 210 defined by the codebook 220 or the output of the AI model 225 over one or more historical SRS transmission occasions.

In some cases, the network entity 105-a may use a model 240-b (e.g., a machine learning model, an AI model) to predict a set of beams prior to generating the SRI 235-b. That is, based on receiving the set of reference signals 230 during the first SRS transmission occasion (e.g., via the SRS resource 205-a and the SRS resource 205-b), and receiving the additional set of reference signals during the second SRS transmission occasion (e.g., via the SRS resource 205-c and the SRS resource 205-d), the network entity 105-a may use the model 240-b to predict a set of beams the UE 115-a may use to most perform uplink transmissions.

In response to receiving the second message including the SRI 235-b, the UE 115-a may transmit a second uplink message 245-b (e.g., a PUSCH) using a second uplink transmission beam 250-b, the second uplink transmission beam 250-b based on the set of beams that correspond to at least one of the two or more SRS resources 205 (e.g., the SRS resource 205-a and the SRS resource 205-b) and the third SRS resource 205 (e.g., the SRS resource 205-c) indicated in the SRI 235-b (e.g., the predicted beams).

In some cases, the network entity 105-a may configure an SRS-usage type associated with the SRS resource set 210. For example, a configured SRS usage type (e.g., SRS-Usage=PredictiveBM) may be associated with the SRS resource set 210 defined by the codebook 220 or the AI model 225. The UE 115-a may receive the message 215 indicating the configured SRS usage type (e.g., a usage type associated with the SRS resource set 210 including the set of SRS resources 205). In some cases, the UE 115-a may report a maximum quantity of configurable SRS resource sets with the configured SRS usage type (e.g., SRS-ResourceSet=PredictiveBM), and a maximum quantity of SRS resources 205 within such an SRS resource set (e.g., the SRS resource set 210) as a UE capability.

In some cases, a linear combination-based PUSCH precoder indication, or an AI-based PUSCH precoder indication, as described herein, may implicitly configure a new uplink transmission configuration indicator (TCI) state associated with the UE 115-a. That is, the UE 115-a may receive the second message including an SRI 235, here the second message may additionally configure the uplink TCI state for the UE 115-a. The implicitly configured TCI state may be associated with at least one of the SRS resources 205 that is directly or indirectly used to determine a spatial precoder for transmitting an uplink message 425. For example, the network entity 105-a may further indicate an SRI 235 associated with at least one of such SRS resources 205 to imply using an uplink transmission beam 250 identified in an uplink message 245 (e.g., PUSCH) transmitted by the UE 115-a. In some examples, the network entity 105-a successfully decoding an uplink message 245 may be considered as an implicit confirmation that the UE 115-a acknowledged the implicit TCI state configuration.

By limiting a quantity of beams for a beam sweeping procedure using the codebook 220 or the AI model 225, communications between the UE 115-a and the network entity 105-a may be improved. For example, by defining the SRS resource set 210 using the codebook 220 or the output of the AI model 225, the UE 115-a may sweep over a portion of a larger set of beams, which may reduce power consumption and overhead consumption at the UE 115-a. In addition, by transmitting an enhanced SRI to the UE 115-a indicating SRS resources 205 of the SRS resource set 210 defined by the codebook 220 or the AI model 225, the network entity 105-a may improve beam predictions and further reduce system overhead as the UE 115-a may use fewer uplink transmission beams. As such, the described techniques may increase the efficiency of beam sweeping, among other benefits.

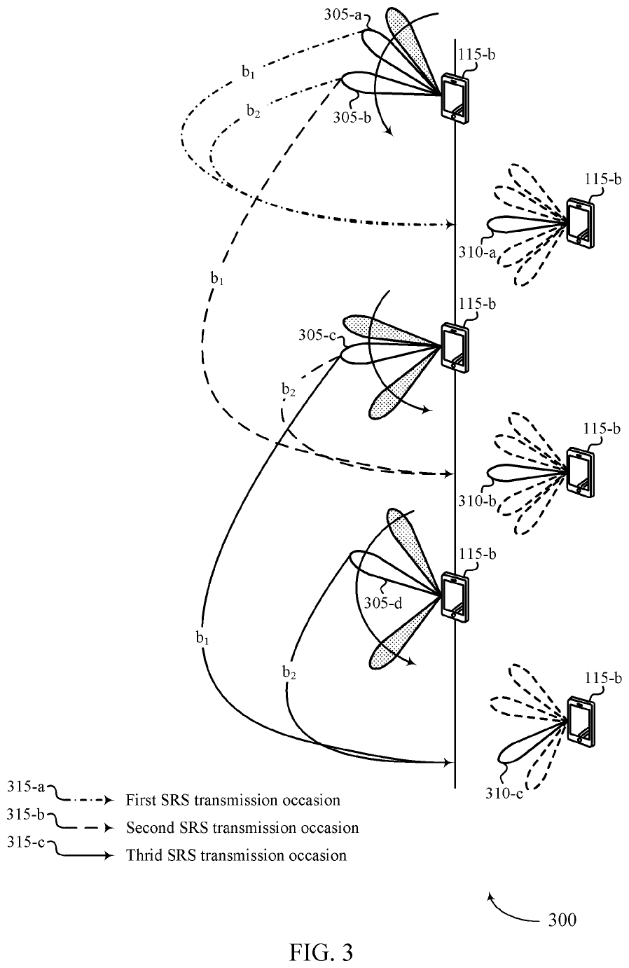

FIG. 3 illustrates an example of a beam-sweep timeline 300 for a UE 115 that supports reference signal resource selection based beam prediction in accordance with one or more aspects of the present disclosure. In some examples, the beam-sweep timeline 300 may implement aspects of the wireless communications system 100 or may be implemented by aspects of the wireless communications system 100. For example, the beam-sweep timeline 300 may include a UE 115-b, which may be an example of corresponding devices described herein. In some examples, the UE 115-b may use time domain beam sweeping to increase beam sweeping efficiency, decrease system overhead, and decrease power consumption in the beam-sweep timeline 300, among other benefits.

As described herein, the UE 115-b may support a quantity of SRS resources 305, which may be associated with transmit beams or receive beams. Some SRS resources 305 may be included in an SRS resource set. The UE 115-b may receive a first message from a network entity indicating an SRS resource set corresponding to a set of reference signal beams or uplink transmit beams for the UE 115-b. For example, the SRS resource set may include a quantity of SRS resources in addition to an SRS resource 305-a, an SRS resource 305-b, an SRS resource 305-c, an SRS resource 305-d, or any combination thereof. In some cases, the network entity may use a codebook or an output of an AI model to determine the SRS resource set. For example, the network entity may transmit the first message indicating a codebook identifying a set of time-varying spatial precoders associated with the set of SRS resources 305 of the SRS resource set, where a given spatial precoder may correspond to a respective uplink transmit beam for the UE 115-b. Alternatively, the network entity may transmit the first message indicating an output of an AI model identifying a set of time-varying spatial precoders associated with the set of SRS resources 305.

In some cases, the UE 115-b may transmit a set of reference signals (e.g., SRSs) using the set of SRS resources 305 and according to the TDM scheme. The network entity may transmit a second message to the UE 115-b indicating an SRI. The SRI may indicate two or more SRS resources 305 of the set of SRS resources, which the UE 115-b may use to transmit an uplink message (e.g., a PUSCH) using an uplink transmission beam 310 determined based on a set of beams that correspond to the two or more SRS resources 305. That is, the SRI may indicate one or more SRS resources 305 that correspond to one or more beams that the UE 115-b may use to communicate uplink transmissions with a network entity. During a first SRS transmission occasion 315-a, the network entity may transmit the second message to the UE 115-b indicating an SRI, where the SRI may indicate the SRS resource 305-a (e.g., corresponding to a first linear coefficient, b₁) and the SRS resource 305-b (e.g., corresponding to a second linear coefficient, b₂). The UE 115-a may transmit a first uplink message (e.g., PUSCH) to the network entity using an uplink transmission beam 310-a, where the uplink transmission beam 310-a may be based on a set of beams that correspond to the SRS resource 305-a and the SRS resource 305-b.

In some examples, the UE 115-b may interpret an SRI at least as a linear combination of the SRS resources 305 included in the SRS resource set over one or multiple previous (e.g., historical) SRS transmission occasions 315, one or more most recent SRS transmission occasions 315, or both. The SRS resources 305 indicted in the SRI may identify a spatial precoder for a scheduled uplink transmission (e.g., PUSCH), where the identified spatial precoder is based on one or more linear combinations of the SRS resources 305 indicated in the SRI. In some examples, the SRS resources 305 may be combined over time-selective SRS precoders. For a given SRS resource indicated in the SRI, an uplink grant that includes the SRI may further indicate one or more previous SRS transmission occasions 315, one or more most recent SRS transmission occasions, or both. The linear combination of the SRS resources 305 may be applied to one or more spatial precoders used by SRS resources 305 for the SRS transmission occasions 315. For example, during a second SRS transmission occasion 315-b, the UE 115-b may receive the second message indicating the SRI from the network entity, where the SRI may indicate a linear combination of two or more SRS resources 305, and where the two or more SRS resources 305 may be associated with different SRS transmission occasions 315. For example, the SRI may indicate a linear combination of the SRS resource 305-b associated with the first SRS transmission occasion 315-a (e.g., corresponding to the linear coefficient b₁), and the SRS resource 305-c associated with the second SRS transmission occasion 315-b (e.g., corresponding to the linear coefficient b₂). As such, the linear combination may include different SRS resources 305 from different SRS transmission occasions 315 (e.g., previous and most recent SRS transmission occasions 315).

The UE 115-b may transmit a second uplink message (e.g., PUSCH) to the network entity using an uplink transmission beam 310-b, where the uplink transmission beam 310-b may be based on a set of beams that correspond to the SRS resource 305-b and the SRS resource 305-c. In addition, the UE 115-b may transmit the second uplink message based on a spatial precoder associated with the linear combination of the SRS resource 305-b and the SRS resource 305-c.

Additionally, or alternatively, during a third SRS transmission occasion 315-c, the UE 115-b may receive the second message indicating the SRI from the network entity, where the SRI may indicate a linear combination of two or more SRS resources 305, and where the two or more SRS resources 305 may be associated with different SRS transmission occasions 315. For example, the SRI may indicate a linear combination of the SRS resource 305-c associated with the second SRS transmission occasion 315-b (e.g., corresponding to the linear coefficient b₁) and the SRS resource 305-d associated with the third SRS transmission occasion 315-c (e.g., corresponding to the linear coefficient b₂). As such, the linear combination may include a same SRS resource 305 (e.g., the SRS resource 305-c and the SRS resource 305-d may correspond to a same physical location and have different spatial precoders) in different SRS transmission occasions 315.

The UE 115-b may transmit a third uplink message (e.g., PUSCH) to the network entity using an uplink transmission beam 310-c, where the uplink transmission beam 310-c may be based on a set of beams that correspond to the SRS resource 305-c and the SRS resource 305-d. In addition, the UE 115-b may transmit the second uplink message based on a spatial precoder associated with the linear combination of the SRS resource 305-b and the SRS resource 305-d.

In some examples, the UE 115-b may report a UE capability for using AI model-defined spatial precoders. For example, for model-based spatial precoders, the UE 115-b may report an upper-bound of a quantity of transmission occasions indicated in one or more uplink grants as a UE capability. In some examples, the UE capability may be based on the UE 115-b memorizing previously used precoders.

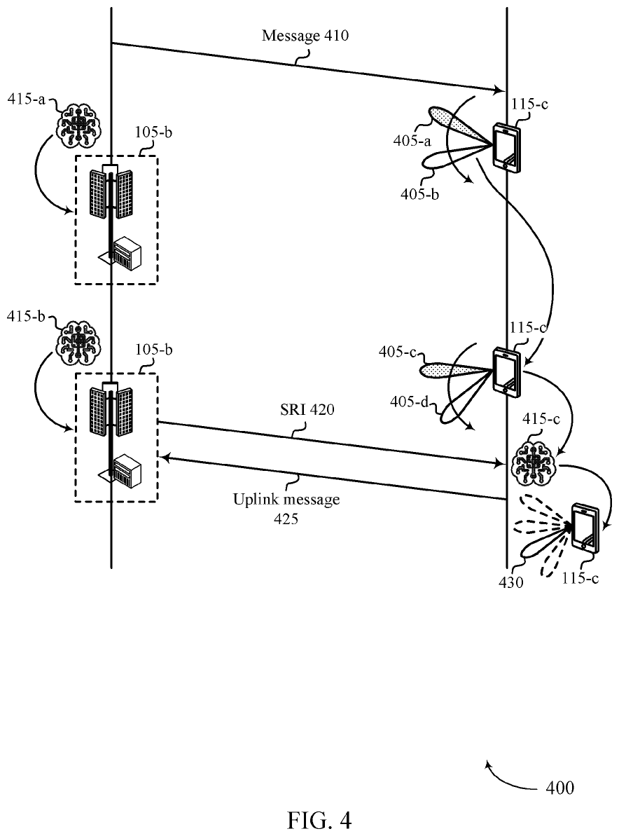

FIG. 4 illustrates an example of a process flow 400 that supports reference signal resource selection based beam prediction in accordance with one or more aspects of the present disclosure. In some examples, the process flow 400 may implement aspects of the wireless communications system 100 or may be implemented by aspects of the wireless communications system 100. For example, the process flow 400 may include a network entity 105-b and a UE 115-c, which may be examples of corresponding devices described herein. In some examples, the network entity 105-b and the UE 115-c may use time domain beam sweeping to increase beam sweeping efficiency, decrease system overhead, and decrease power consumption in a wireless communications system, among other benefits.

As described with reference to FIGS. 2, the network entity 105-b may communicate signals (e.g., uplink and downlink transmissions) with the UE 115-c over respective communication links. In some examples, the UE 115-c may support a quantity of SRS resources 405, which may be associated with transmit beams or receive beams. Some SRS resources 405 may be included in an SRS resource set.

To support SRS resource selection-based beam predictions by the network entity 105-b, the network entity 105-b may transmit a message 410 to the UE 115-c indicating the SRS resource set, where the SRS resource set may include a set of SRS resources associated with a TDM scheme. For example, the SRS resource set may include an SRS resource 405-a and an SRS resource 405-b, which may be TDMed. In some examples, the SRS resources 405 included in the SRS resource set may be associated with a set of time-varying spatial precoders. The UE 115-c may transmit a set of reference signals to the network entity 105-b using the SRS resources 405 included in the SRS resource set and according to the TDM scheme.

In some examples, the UE 115-c and the network entity 105-b may use AI models to determine precoders for a scheduled uplink transmission. As described herein, the network entity 105-b may use a model 415 (e.g., an AI model) to predict a set of beams corresponding to two or more SRS resources 405 which the UE 115-c may use to transmit an uplink message 425. For example, the network entity 105-b may use a model 415-a to predict a set of beams corresponding to the SRS resource 405-a and the SRS resource 405-b, which may be included in an SRS resource set. Additionally, or alternatively, the network entity 105-b may use a model 415-b to predict a set of beams corresponding to an SRS resource 405-c and an SRS resource 405-d, which may be included in the SRS resource set.

The network entity 105-b may transmit a second message to the UE 115-c indicating an uplink grant and an SRI 420, where the SRI 420 may include a portion of the total quantity of SRS resources 405 of the SRS resource set. The SRI 420 may indicate one or more SRS resources 405 that correspond to one or more beams that the UE 115-c may use to communicate uplink transmissions with the network entity 105-b. In some examples, the SRI 420 may include a linear combination of SRS resources 405 from one or more SRS transmission occasions. For example, using the model 415-b, the network entity 105-b may generate a linear combination that includes the SRS resource 405-b, which may be associated with a first SRS transmission occasion, and the SRS resource 405-d, which may be associated with a second SRS transmission occasion.

In some examples, the SRS resources 405 (e.g., the SRS resource 405-b and the SRS resource 405-d) indicated in the SRI 420 may identify a spatial precoder for an uplink message 425 (e.g., a scheduled PUSCH). The spatial precoder may be based on an output of a model 415-c that may use at least the SRI 420 as an input. Additional inputs to the model 415-c may include one or more CSI-RS tones associated with the SRS resource set, a channel estimated from the CSI-RS, or both. As such, the UE 115-c may transmit the uplink message 425 using an uplink transmission beam 430 that corresponds to a spatial precoder determined at the UE 115-c using the model 415-c, where the spatial precoder may have improved accuracy and efficiency based on the use of the model 415-c.

In some cases, the SRI 420 input to the model 415-c may include one or more bits indicated in the SRI 420, the SRS resources 405 indicated in the SRI 420 together with corresponding SRS transmission occasions indicated in the uplink grant transmitted by the network entity 105-b, as described with reference to FIG. 4, additional information such as UE-rotation information (e.g., which may be unavailable at the network entity 105-b), or any combination thereof. In some examples, if the SRI 420 includes a limited quantity of bits, thus resulting in the information within the SRI 420 being compressed (e.g., encoded), the model 415-c may decompress (e.g., decode) the information in the SRI 420 to determine the spatial precoder for the uplink message 425.

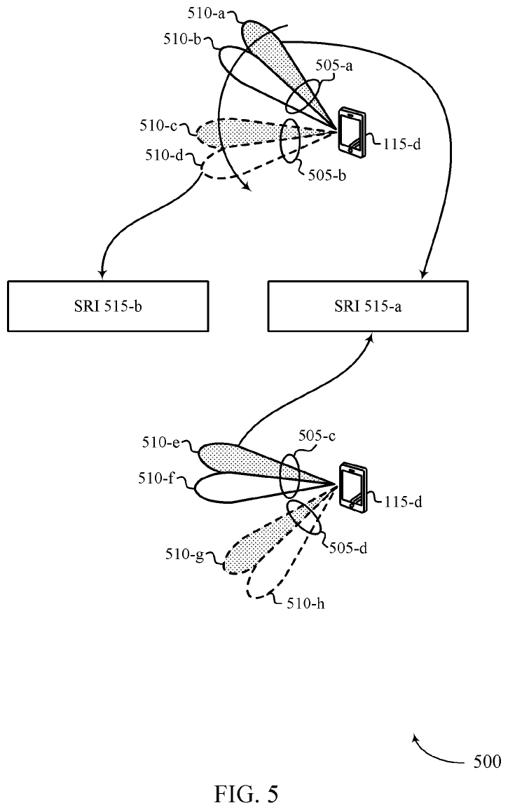

FIG. 5 illustrates an example of an SRI mapping scheme 500 that supports reference signal resource selection based beam prediction in accordance with one or more aspects of the present disclosure. In some examples, the SRI mapping scheme 500 may implement aspects of the wireless communications system 100 or may be implemented by aspects of the wireless communications system 100. For example, the SRI mapping scheme 500 may include a UE 115-d, which may be an example of corresponding devices described herein. In some examples, the UE 115-d may use time domain beam sweeping to increase beam sweeping efficiency, decrease system overhead, and decrease power consumption in a wireless communications system, among other benefits.

As described herein, the UE 115-d may support a quantity of SRS resources 505, which may be transmit beams or receive beams. Some SRS resources 505 may be included in an SRS resource set. The UE 115-d may receive a first message from a network entity indicating an SRS resource set that includes a set of SRS resources 505 associated with a TDM scheme. For example, the SRS resource set may include a quantity of SRS resources 505 including an SRS resource 505-a (e.g., SRS-Rsc#0), an SRS resource 505-b (e.g., SRS-Rsc#1), an SRS resource 505-c (e.g., SRS-Rsc#0), an SRS resource 505-d (e.g., SRS-Rsc#1), or any combination thereof. In some examples, the SRS resources 505 may be associated with different SRS transmission occasions. For example, the UE 115-d may use the SRS resource 505-a and the SRS resource 505-b during a first SRS transmission occasion (e.g., SRS Tx Occasion #0), and the SRS resource 505-c and the SRS resource 505-d during a second SRS transmission occasion (e.g., SRS Tx Occasion #1).

The network entity may use a codebook or an output of an AI model to determine the SRS resource set. For example, the network entity may transmit the first message indicating a codebook identifying a set of time-varying spatial precoders associated with the set of SRS resources 505 of the SRS resource set, or the network entity may transmit the first message indicating an output of an AI model identifying a set of time-varying spatial precoders associated with the set of SRS resources 505. In some cases, the UE 115-d may transmit a set of reference signals (e.g., SRSs) using the set of SRS resources 505 and according to the TDM scheme, and in some cases, the set of time-varying spatial precoders. The network entity may transmit a second message to the UE 115-d indicating an SRI 515. The SRI 515 may indicate two or more SRS resources 505 of the set of SRS resources, which the UE 115-d may use to transmit an uplink message (e.g., a PUSCH) using an uplink transmission beam determined based on a set of beams that correspond to the two or more SRS resources 505. In some examples, the UE 115-d may interpret an SRI 515 at least as a linear combination of the SRS resources 505 included in the SRS resource set over one or multiple previous (e.g., historical) SRS transmission occasions, one or more most recent SRS transmission occasions, or both.

In some examples, in addition to the two or more SRS resources 505, the SRI 515 may indicate a rank such that the time-variant spatial precoders, and in some cases, their linear combinations associated with different SRS resources 505, may be interpreted as a spatial precoder to be used with different PUSCH demodulation reference signal (DMRS) ports. As such, the UE 115-d may receive a message from the network entity based on a spatial precoder associated with the rank of the SRI, the spatial precoder used with different PUSCH DMRS ports (e.g., SRS ports 510). For example, if the SRI 515 indicates a linear combination of SRS resources 505, the UE 115-d may interpret the SRI 515 as having a first linear combination of SRS resources 505 for a first PUSCH layer and a second linear combination of SRS resources 505 for a second PUSCH layer. Alternatively, if the SRI 515 is based on a single AI model as described with reference to FIG. 2, the UE 115-d may interpret the SRI 515 as an input to the AI-model, which may determine a first spatial precoder and a second spatial precoder to be used for the first PUSCH layer and the second PUSCH layer, respectively. If the SRI 515 is based on multiple AI models, the multiple AI models may be used to output the multiple spatial precoders for the first and second PUSCH layers.

In some cases of higher-rank SRI indications, spatial precoders previously used by a same SRS resource 505, a same portion of SRS resources 505, or both, may be linearly combined for the same PUSCH layer, or input to a corresponding AI model (if multiple AI models are used) to determine the spatial precoder for the corresponding PUSCH layer. In addition, some restrictions on linear combinations for higher-rank SRI indications may be based on UE capability reporting (e.g., reporting a quantity of SRS resources 505 that may be used within a portion of SRS resources 505).

In some examples, each SRS resource 505 may correspond to multiple SRS ports 510 supported by the UE 115-d. For example, multiple SRS ports 510 which the UE 115-d may simultaneously transmit may be carried by a single SRS resource 505. For a first SRS transmission occasion, the SRS resource 505-a may be associated with an SRS port 510-a (e.g., SRS-port#0) and an SRS port 510-b (e.g., SRS-port#1), and the SRS resource 505-b may be associated with an SRS port 510-c (e.g., SRS-port#0) and an SRS port 510-d (e.g., SRS-port#1). In addition, for a second SRS transmission occasion, the SRS resource 505-c may be associated with an SRS port 510-e (e.g., SRS-port#0) and an SRS port 510-f (e.g., SRS-port#1), and the SRS resource 505-d may be associated with an SRS port 510-g (e.g., SRS-port#0) and an SRS port 510-h (e.g., SRS-port#1). The UE 115-d may simultaneously transmit each pair of SRS ports 510 corresponding to a single SRS resource 505.

In addition, multiple spatial precoders may be mapped to the multiple SRS ports 510. In some examples, for a linear combination-based SRI indication, an SRI 515-a may indicate a linear combination of spatial precoders used for a same SRS resource 505 and a same SRS port 510 for generating a spatial precoder for a same PUSCH layer. For example, for a first PUSCH layer (e.g., PUSCH layer #0), the SRI 515-a may include a linear combination of spatial precoders used for the SRS resource 505-a associated with the SRS port 510-a during the first SRS transmission occasion, and for the SRS resource 505-c associated with the SRS port 510-e during the second SRS transmission occasion.

Alternatively, for an AI model-based SRI indication, one or more previously-used spatial precoders used with a same SRS resource 505 and a same SRS port 510 may be used as an input for the AI model associated with a particular PUSCH layer. For example, for a second PUSCH layer (e.g., PUSCH layer #1), an SRI 515-b may include a linear combination of spatial precoders used for the SRS resource 505-b associated with the SRS port 510-d during the first SRS transmission occasion, and for the SRS resource 505-d associated with the SRS port 510-h during the second SRS transmission occasion.

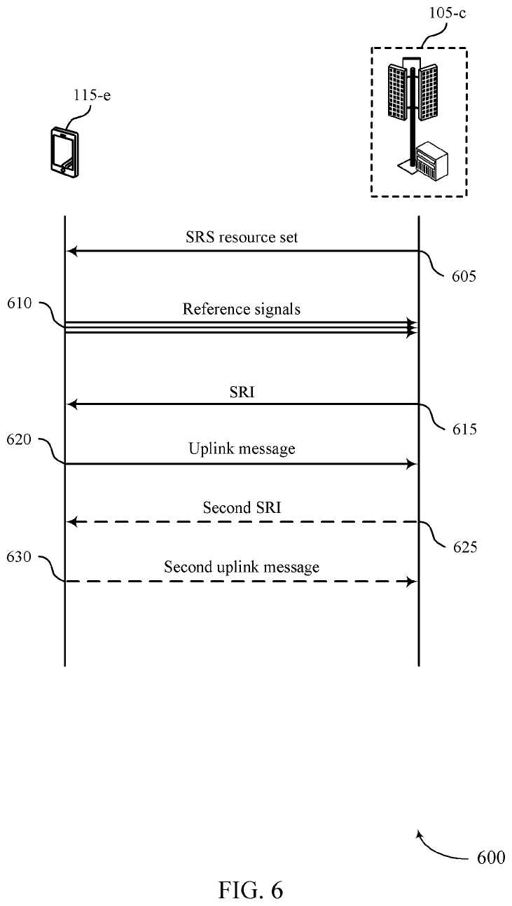

FIG. 6 illustrates an example of a process flow 600 that supports reference signal resource selection based beam prediction in accordance with one or more aspects of the present disclosure. The process flow 600 may implement aspects of the wireless communications system 100, or may be implemented by aspects of the wireless communications system 100. For example, the process flow 600 may illustrate operations between a UE 115-e and a network entity 105-c, which may be examples of corresponding devices described herein. In the following description of the process flow 600, the operations between the UE 115-e and the network entity 105-c may be transmitted in a different order than the example order shown, or the operations performed by the UE 115-e and the network entity 105-c may be performed in different orders or at different times. Some operations may also be omitted from the process flow 600, and other operations may be added to the process flow 600.

At 605, the UE 115-e may receive, from the network entity 105-c, a first message indicating an SRS resource set including a set of SRS resources associated with a TDM scheme. In addition, the set of SRS resources may be associated with a set of time-varying spatial precoders. In some examples, the UE 115-e may receive the first message indicating a codebook or an output of an AI model, which may identify the set of time-varying spatial precoders associated with the set of SRS resources.

At 610, the UE 115-e may transmit, to the network entity 105-c, a set of reference signals (e.g., SRSs) using the set of SRS resources and according to the TDM scheme. If configured, the UE 115-e may transmit the set of reference signals using the set of time-varying spatial precoders.

At 615, the UE 115-e may receive, from the network entity 105-c, a second message including an SRI indicating two or more SRS resources of the set of SRS resources. The SRI may indicate a linear combination of the two or more SRS resources, where the two or more SRS resources may be associated with one or more SRS transmission occasions. That is, the linear combination may indicate the two or more SRS resources which may be from previous SRS transmissions occasions, most recent SRS transmission occasions, or both.

At 620, the UE 115-e may transmit, to the network entity 105-c, a first uplink message using a first uplink transmission beam. The first uplink transmission beam may be based on a set of beams that correspond to the two or more SRS resources included in the SRI. That is, the network entity 105-c may make a beam prediction based on the set of SRS resources. In some cases, the UE 115-e may transmit the first uplink message (e.g., a PUSCH) using the first uplink transmission beam and a spatial precoder determined by the network entity 105-c, the UE 115-e, or both.

At 625, the UE 115-e may receive, from the network entity 105-c, a third message including a second SRI indicating at least one of the two or more SRS resources and a third SRS resource from the set of SRS resources. The at least one of the two or more SRS resources may be from a first SRS transmission occasion, and the third SRS resource may be from a second SRS transmission occasion. That is, at least the third SRS resource may be from a previous (e.g., historical) SRS transmission occasion, a most recent SRS transmission occasion, or both.

At 630, the UE 115-e may transmit, to the network entity 105-c, a second uplink message (e.g., a PUSCH) using a second uplink transmission beam, the second uplink transmission beam based on a second set of beams that correspond to the at least one of the two or more SRS resources and the third SRS resources. In some examples, the second uplink transmission beam may be associated with a spatial precoder.

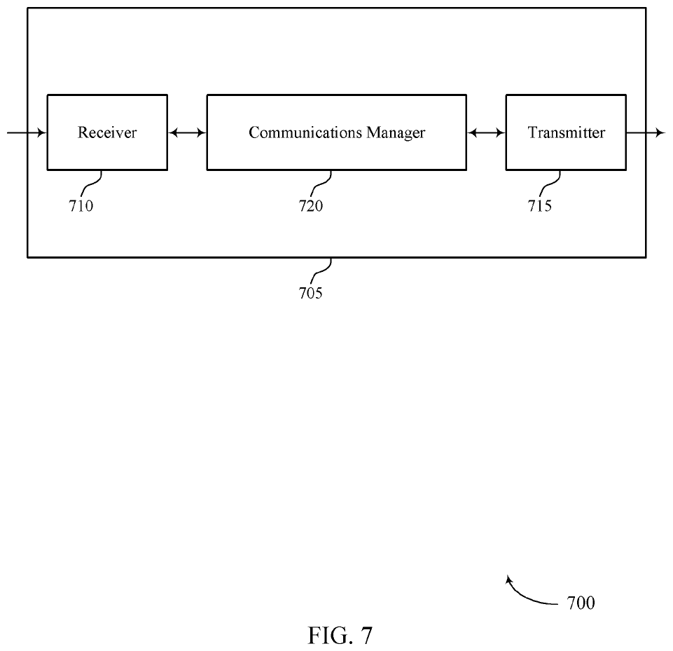

FIG. 7 shows a block diagram 700 of a device 705 that supports reference signal resource selection based beam prediction in accordance with one or more aspects of the present disclosure. The device 705 may be an example of aspects of a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to reference signal resource selection based beam prediction). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to reference signal resource selection based beam prediction). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of reference signal resource selection based beam prediction as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), a central processing unit (CPU), a graphics processing unit (GPU) an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 720, the receiver 710, the transmitter 715, or various combinations or components thereof may be implemented in hardware, software (e.g., executed by a processor), or any combination thereof. If implemented in code executed by a processor, the functions of the communications manager 720, the receiver 710, the transmitter 715, or various combinations or components thereof may be performed by a general-purpose processor, a DSP, a CPU, a GPU an ASIC, an FPGA, a microcontroller, or any combination of these or other programmable logic devices (e.g., configured as or otherwise supporting a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a UE in accordance with examples as disclosed herein. For example, the communications manager 720 may be configured as or otherwise support a means for receiving a first message indicating a reference signal resource set including a set of multiple reference signal resources associated with a TDM scheme. The communications manager 720 may be configured as or otherwise support a means for transmitting a set of multiple reference signals using the set of multiple reference signal resources according to the TDM scheme. The communications manager 720 may be configured as or otherwise support a means for receiving a second message including a reference signal resource indicator indicating two or more reference signal resources of the set of multiple reference signal resources. The communications manager 720 may be configured as or otherwise support a means for transmitting a first uplink message using a first uplink transmission beam, the first uplink transmission beam based on a set of beams that correspond to the two or more reference signal resources.

By including or configuring the communications manager 720 in accordance with examples as described herein, the device 705 (e.g., a processor controlling or otherwise coupled with the receiver 710, the transmitter 715, the communications manager 720, or a combination thereof) may support techniques for reference signal resource selection-based beam predictions, which may reduce power and overhead consumption for the device 705. As such, the described techniques may support improved beam sweeping and SRI generation, among other benefits.

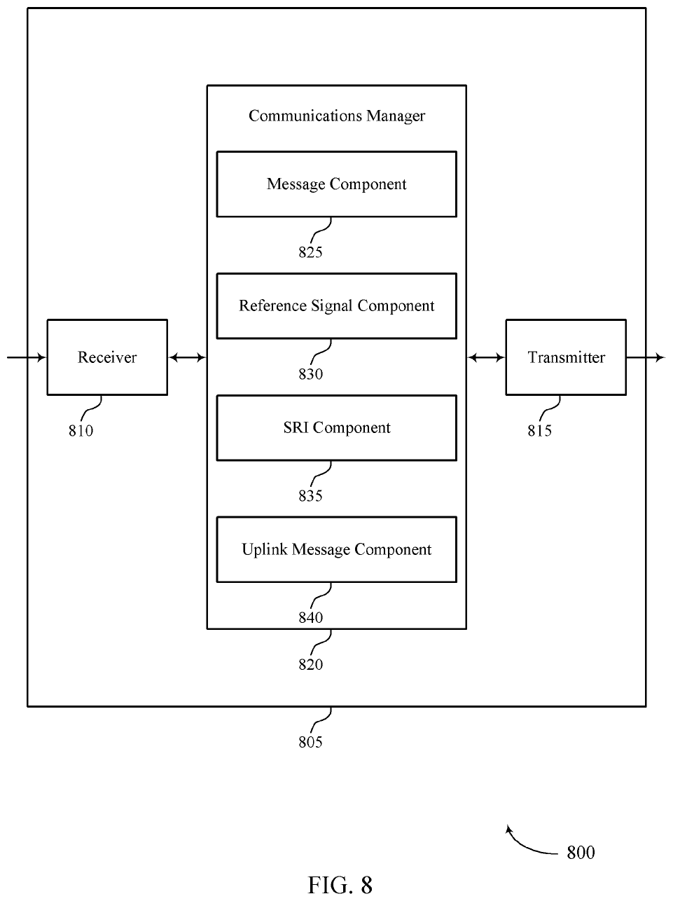

FIG. 8 shows a block diagram 800 of a device 805 that supports reference signal resource selection based beam prediction in accordance with one or more aspects of the present disclosure. The device 805 may be an example of aspects of a device 705 or a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to reference signal resource selection based beam prediction). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to reference signal resource selection based beam prediction). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of reference signal resource selection based beam prediction as described herein. For example, the communications manager 820 may include a message component 825, a reference signal component 830, an SRI component 835, an uplink message component 840, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at a UE in accordance with examples as disclosed herein. The message component 825 may be configured as or otherwise support a means for receiving a first message indicating a reference signal resource set including a set of multiple reference signal resources associated with a TDM scheme. The reference signal component 830 may be configured as or otherwise support a means for transmitting a set of multiple reference signals using the set of multiple reference signal resources according to the TDM scheme. The SRI component 835 may be configured as or otherwise support a means for receiving a second message including a reference signal resource indicator indicating two or more reference signal resources of the set of multiple reference signal resources. The uplink message component 840 may be configured as or otherwise support a means for transmitting a first uplink message using a first uplink transmission beam, the first uplink transmission beam based on a set of beams that correspond to the two or more reference signal resources.

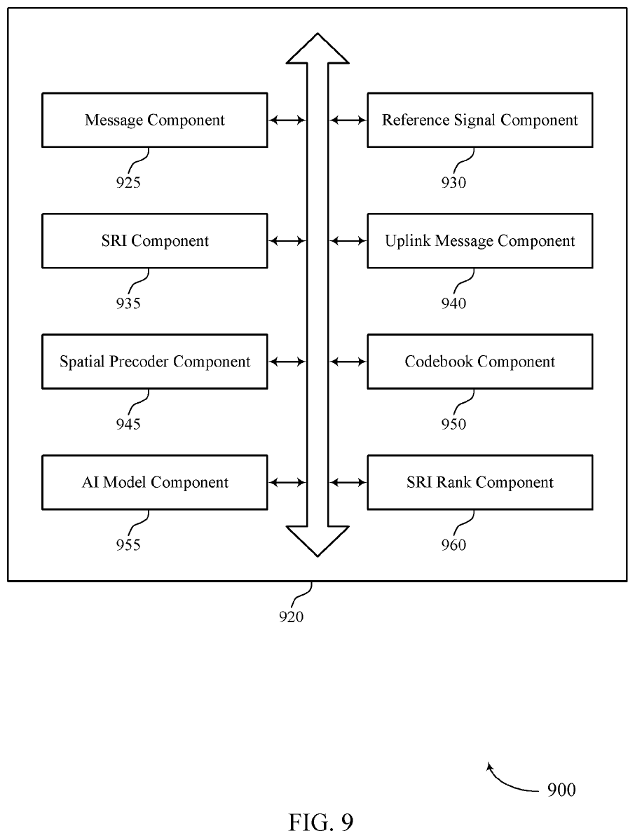

FIG. 9 shows a block diagram 900 of a communications manager 920 that supports reference signal resource selection based beam prediction in accordance with one or more aspects of the present disclosure. The communications manager 920 may be an example of aspects of a communications manager 720, a communications manager 820, or both, as described herein. The communications manager 920, or various components thereof, may be an example of means for performing various aspects of reference signal resource selection based beam prediction as described herein. For example, the communications manager 920 may include a message component 925, a reference signal component 930, an SRI component 935, an uplink message component 940, a spatial precoder component 945, a codebook component 950, an AI model component 955, an SRI rank component 960, or any combination thereof. Each of these components may communicate, directly or indirectly, with one another (e.g., via one or more buses).

The communications manager 920 may support wireless communication at a UE in accordance with examples as disclosed herein. The message component 925 may be configured as or otherwise support a means for receiving a first message indicating a reference signal resource set including a set of multiple reference signal resources associated with a TDM scheme. The reference signal component 930 may be configured as or otherwise support a means for transmitting a set of multiple reference signals using the set of multiple reference signal resources according to the TDM scheme. The SRI component 935 may be configured as or otherwise support a means for receiving a second message including a reference signal resource indicator indicating two or more reference signal resources of the set of multiple reference signal resources. The uplink message component 940 may be configured as or otherwise support a means for transmitting a first uplink message using a first uplink transmission beam, the first uplink transmission beam based on a set of beams that correspond to the two or more reference signal resources.

In some examples, the SRI component 935 may be configured as or otherwise support a means for receiving a third message including a second reference signal resource indicator indicating at least one of the two or more reference signal resources and a third reference signal resource of the set of multiple reference signal resources. In some examples, the uplink message component 940 may be configured as or otherwise support a means for transmitting a second uplink message using a second uplink transmission beam, the second uplink transmission beam based on a second set of beams that correspond to the at least one of the two or more reference signal resources and the third reference signal resource.

In some examples, to support transmitting the set of multiple reference signals, the spatial precoder component 945 may be configured as or otherwise support a means for transmitting the set of multiple reference signals using the set of multiple reference signal resources according to the TDM scheme and a set of multiple time-varying spatial precoders associated with the set of multiple reference signal resources.

In some examples, the set of multiple time-varying spatial precoders are different for different transmission occasions of the set of multiple reference signals. In some examples, the set of multiple reference signals are transmitted according to a periodicity or semi-persistently.

In some examples, to support receiving the first message, the codebook component 950 may be configured as or otherwise support a means for receiving the first message indicating codebook identifying a set of multiple time-varying spatial precoders associated with the set of multiple reference signal resources of the reference signal resource set. In some examples, the codebook is time-variant based on an indication from a network entity or the UE.

In some examples, to support receiving the first message, the AI model component 955 may be configured as or otherwise support a means for receiving the first message indicating an output of a machine learning model identifying a set of multiple time-varying spatial precoders associated with the set of multiple reference signal resources of the reference signal resource set. In some examples, the machine learning model is time-variant based on an indication from a network entity or the UE.

In some examples, to support receiving the second message, the SRI component 935 may be configured as or otherwise support a means for receiving the second message including the reference signal resource indicator indicating a linear combination of the two or more reference signal resources of the set of multiple reference signal resources, where the two or more reference signal resources are associated with one or more transmission occasions.

In some examples, to support transmitting the first uplink message, the uplink message component 940 may be configured as or otherwise support a means for transmitting the first uplink message based on a spatial precoder associated with the linear combination of the two or more reference signal resources.

In some examples, to support transmitting the first uplink message, the uplink message component 940 may be configured as or otherwise support a means for transmitting the first uplink message based on a spatial precoder output by a machine learning model, where the machine learning model uses at least the reference signal resource indicator as an input.

In some examples, to support receiving the second message, the SRI rank component 960 may be configured as or otherwise support a means for receiving the second message including the reference signal resource indicator indicating the two or more reference signal resources and including a rank of the reference signal resource indicator.

In some examples, to support transmitting the first uplink message, the SRI rank component 960 may be configured as or otherwise support a means for transmitting the first uplink message based on a spatial precoder associated with the rank of the reference signal resource indicator, where the spatial precoder is used with different reference signal ports.

In some examples, to support receiving the first message, the message component 925 may be configured as or otherwise support a means for receiving the first message indicating a usage type associated with the reference signal resource set including the set of multiple reference signal resources.

In some examples, to support receiving the second message, the message component 925 may be configured as or otherwise support a means for receiving the second message including the reference signal resource indicator, where the second message configures an uplink TCI state for the UE.

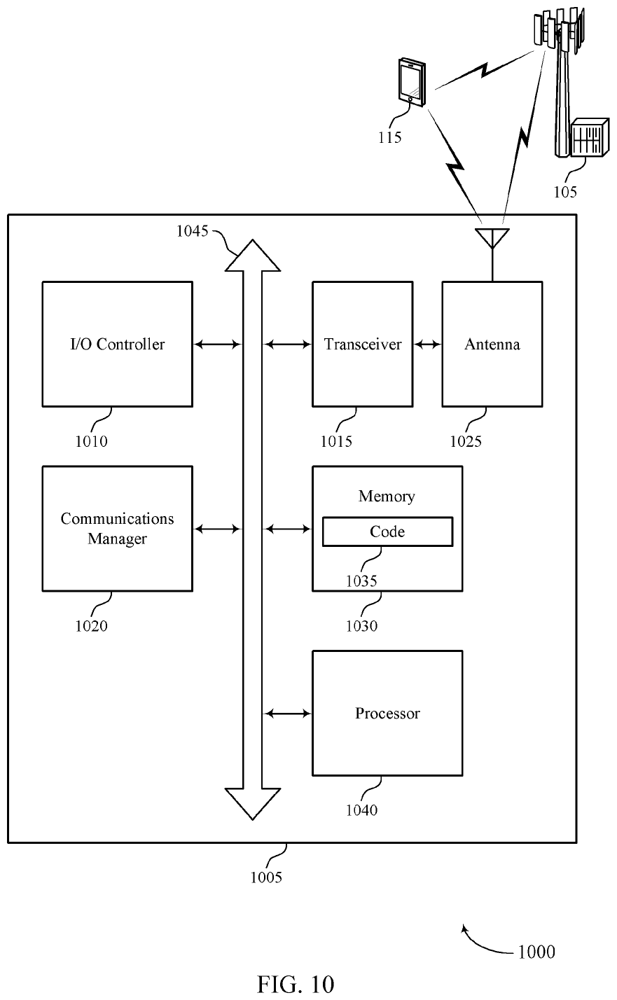

FIG. 10 shows a diagram of a system 1000 including a device 1005 that supports reference signal resource selection based beam prediction in accordance with one or more aspects of the present disclosure. The device 1005 may be an example of or include the components of a device 705, a device 805, or a UE 115 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a GPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting reference signal resource selection based beam prediction). For example, the device 1005 or a component of the device 1005 may include a processor 1040 and memory 1030 coupled with or to the processor 1040, the processor 1040 and memory 1030 configured to perform various functions described herein.

The communications manager 1020 may support wireless communication at a UE in accordance with examples as disclosed herein. For example, the communications manager 1020 may be configured as or otherwise support a means for receiving a first message indicating a reference signal resource set including a set of multiple reference signal resources associated with a TDM scheme. The communications manager 1020 may be configured as or otherwise support a means for transmitting a set of multiple reference signals using the set of multiple reference signal resources according to the TDM scheme. The communications manager 1020 may be configured as or otherwise support a means for receiving a second message including a reference signal resource indicator indicating two or more reference signal resources of the set of multiple reference signal resources. The communications manager 1020 may be configured as or otherwise support a means for transmitting a first uplink message using a first uplink transmission beam, the first uplink transmission beam based on a set of beams that correspond to the two or more reference signal resources.

By including or configuring the communications manager 1020 in accordance with examples as described herein, the device 1005 may support techniques for reference signal resource selection-based beam predictions, which may reduce power and overhead consumption for the device 1005. As such, the described techniques may support improved beam sweeping and SRI generation, among other benefits.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of reference signal resource selection based beam prediction as described herein, or the processor 1040 and the memory 1030 may be otherwise configured to perform or support such operations.

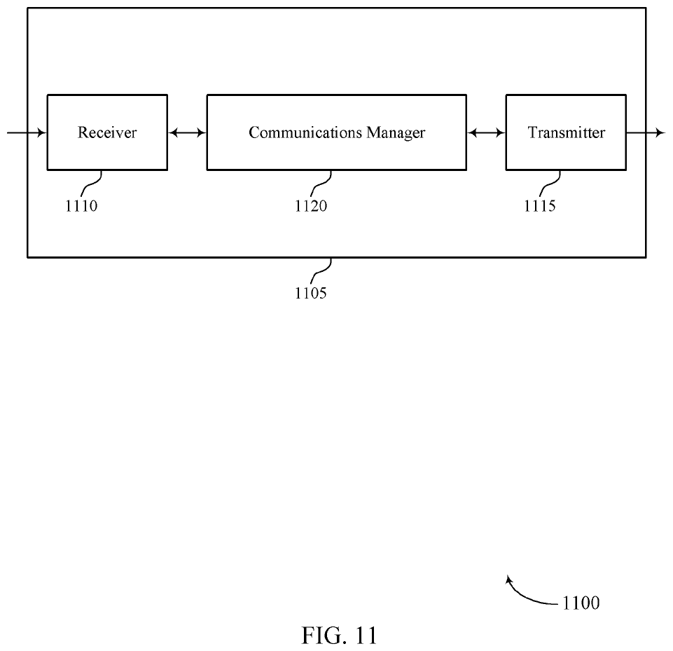

FIG. 11 shows a block diagram 1100 of a device 1105 that supports reference signal resource selection based beam prediction in accordance with one or more aspects of the present disclosure. The device 1105 may be an example of aspects of a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations thereof or various components thereof may be examples of means for performing various aspects of reference signal resource selection based beam prediction as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include a processor, a DSP, a CPU, a GPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1120, the receiver 1110, the transmitter 1115, or various combinations or components thereof may be implemented in hardware, software (e.g., executed by a processor), or any combination thereof. If implemented in code executed by a processor, the functions of the communications manager 1120, the receiver 1110, the transmitter 1115, or various combinations or components thereof may be performed by a general-purpose processor, a DSP, a CPU, a GPU an ASIC, an FPGA, a microcontroller, or any combination of these or other programmable logic devices (e.g., configured as or otherwise supporting a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a network entity in accordance with examples as disclosed herein. For example, the communications manager 1120 may be configured as or otherwise support a means for transmitting a first message indicating a reference signal resource set including a set of multiple reference signal resources associated with a TDM scheme. The communications manager 1120 may be configured as or otherwise support a means for receiving a set of multiple reference signals using the set of multiple reference signal resources according to the TDM scheme. The communications manager 1120 may be configured as or otherwise support a means for transmitting a second message including a reference signal resource indicator indicating two or more reference signal resources of the set of multiple reference signal resources. The communications manager 1120 may be configured as or otherwise support a means for receiving a first uplink message using a first uplink transmission beam, the first uplink transmission beam based on a set of beams that correspond to the two or more reference signal resources.

By including or configuring the communications manager 1120 in accordance with examples as described herein, the device 1105 (e.g., a processor controlling or otherwise coupled with the receiver 1110, the transmitter 1115, the communications manager 1120, or a combination thereof) may support techniques for reference signal resource selection-based beam predictions, which may reduce power and overhead consumption for the device 1105. As such, the described techniques may support improved beam sweeping and SRI generation, among other benefits.

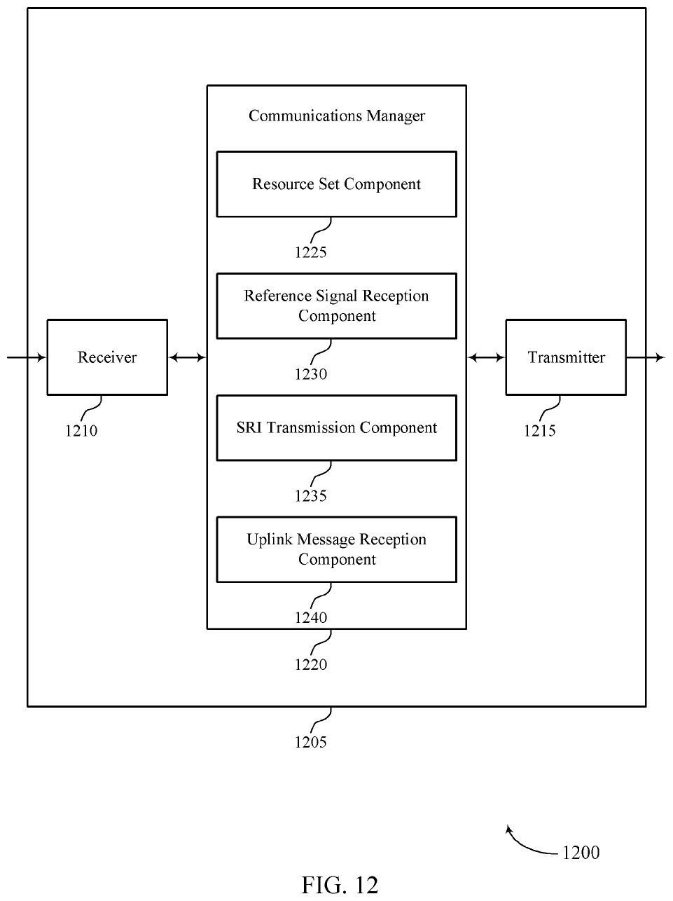

FIG. 12 shows a block diagram 1200 of a device 1205 that supports reference signal resource selection based beam prediction in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of reference signal resource selection based beam prediction as described herein. For example, the communications manager 1220 may include a resource set component 1225, a reference signal reception component 1230, an SRI transmission component 1235, an uplink message reception component 1240, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communication at a network entity in accordance with examples as disclosed herein. The resource set component 1225 may be configured as or otherwise support a means for transmitting a first message indicating a reference signal resource set including a set of multiple reference signal resources associated with a TDM scheme. The reference signal reception component 1230 may be configured as or otherwise support a means for receiving a set of multiple reference signals using the set of multiple reference signal resources according to the TDM scheme. The SRI transmission component 1235 may be configured as or otherwise support a means for transmitting a second message including a reference signal resource indicator indicating two or more reference signal resources of the set of multiple reference signal resources. The uplink message reception component 1240 may be configured as or otherwise support a means for receiving a first uplink message using a first uplink transmission beam, the first uplink transmission beam based on a set of beams that correspond to the two or more reference signal resources.

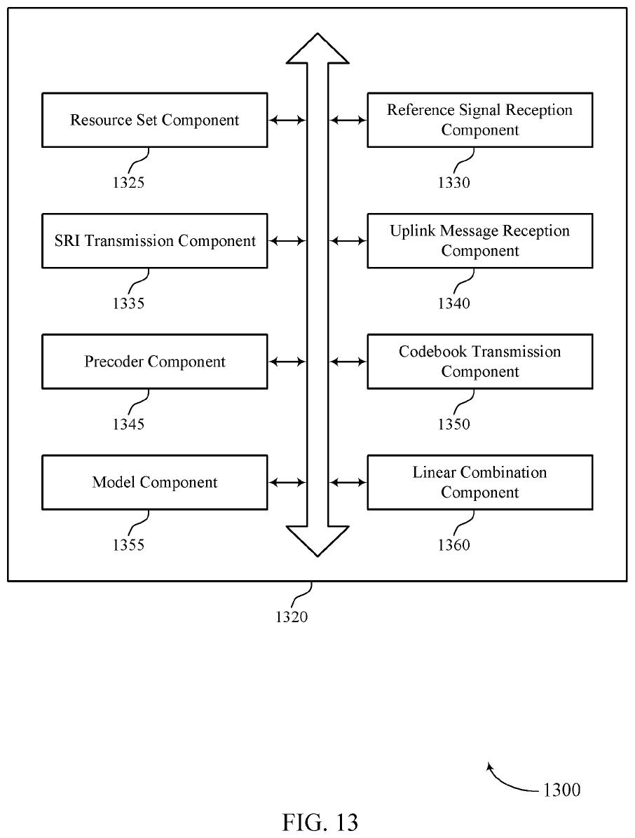

FIG. 13 shows a block diagram 1300 of a communications manager 1320 that supports reference signal resource selection based beam prediction in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of reference signal resource selection based beam prediction as described herein. For example, the communications manager 1320 may include a resource set component 1325, a reference signal reception component 1330, an SRI transmission component 1335, an uplink message reception component 1340, a precoder component 1345, a codebook transmission component 1350, a model component 1355, a linear combination component 1360, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communication at a network entity in accordance with examples as disclosed herein. The resource set component 1325 may be configured as or otherwise support a means for transmitting a first message indicating a reference signal resource set including a set of multiple reference signal resources associated with a TDM scheme. The reference signal reception component 1330 may be configured as or otherwise support a means for receiving a set of multiple reference signals using the set of multiple reference signal resources according to the TDM scheme. The SRI transmission component 1335 may be configured as or otherwise support a means for transmitting a second message including a reference signal resource indicator indicating two or more reference signal resources of the set of multiple reference signal resources. The uplink message reception component 1340 may be configured as or otherwise support a means for receiving a first uplink message using a first uplink transmission beam, the first uplink transmission beam based on a set of beams that correspond to the two or more reference signal resources.

In some examples, the SRI transmission component 1335 may be configured as or otherwise support a means for transmitting a third message including a second reference signal resource indicator indicating at least one of the two or more reference signal resources and a third reference signal resource of the set of multiple reference signal resources. In some examples, the uplink message reception component 1340 may be configured as or otherwise support a means for receiving a second uplink message using a second uplink transmission beam, the second uplink transmission beam based on a second set of beams that correspond to the at least one of the two or more reference signal resources and the third reference signal resource.

In some examples, to support receiving the set of multiple reference signals, the precoder component 1345 may be configured as or otherwise support a means for receiving the set of multiple reference signals using the set of multiple reference signal resources according to the TDM scheme and a set of multiple time-varying spatial precoders associated with the set of multiple reference signal resources.

In some examples, the set of multiple time-varying spatial precoders are different for different transmission occasions of the set of multiple reference signals, where the set of multiple reference signals are transmitted according to a periodicity or semi-persistently.

In some examples, to support transmitting the first message, the codebook transmission component 1350 may be configured as or otherwise support a means for transmitting the first message indicating codebook identifying a set of multiple time-varying spatial precoders associated with the set of multiple reference signal resources of the reference signal resource set. In some examples, codebook is time-variant based on an indication from the network entity or a UE.

In some examples, to support transmitting the first message, the model component 1355 may be configured as or otherwise support a means for transmitting the first message indicating an output of a machine learning model identifying a set of multiple time-varying spatial precoders associated with the set of multiple reference signal resources of the reference signal resource set. In some examples, the machine learning model is time-variant based on an indication from the network entity or a UE.

In some examples, to support transmitting the second message, the linear combination component 1360 may be configured as or otherwise support a means for transmitting the second message including the reference signal resource indicator indicating a linear combination of the two or more reference signal resources of the set of multiple reference signal resources, where the two or more reference signal resources are associated with one or more transmission occasions.

In some examples, to support transmitting the second message, the SRI transmission component 1335 may be configured as or otherwise support a means for transmitting the second message including the reference signal resource indicator indicating the two or more reference signal resources and including a rank of the reference signal resource indicator.

In some examples, to support transmitting the first message, the resource set component 1325 may be configured as or otherwise support a means for transmitting the first message indicating a usage type associated with the reference signal resource set including the set of multiple reference signal resources.

In some examples, to support transmitting the second message, the resource set component 1325 may be configured as or otherwise support a means for transmitting the second message including the reference signal resource indicator, where the second message configures an uplink TCI state for a UE.

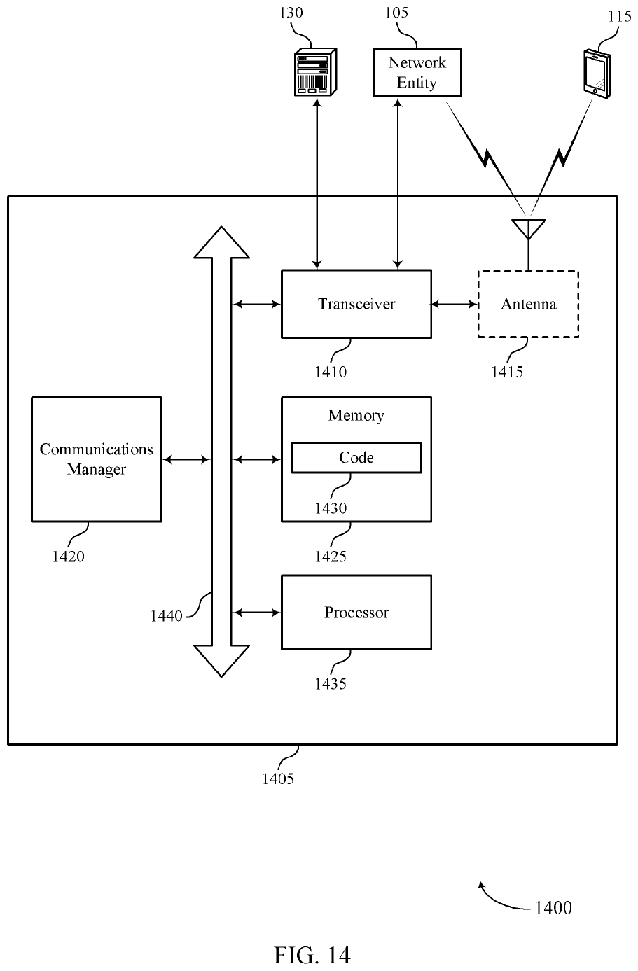

FIG. 14 shows a diagram of a system 1400 including a device 1405 that supports reference signal resource selection based beam prediction in accordance with one or more aspects of the present disclosure. The device 1405 may be an example of or include the components of a device 1105, a device 1205, or a network entity 105 as described herein. The device 1405 may communicate with one or more network entities 105, one or more UEs 115, or any combination thereof, which may include communications over one or more wired interfaces, over one or more wireless interfaces, or any combination thereof. The device 1405 may include components that support outputting and obtaining communications, such as a communications manager 1420, a transceiver 1410, an antenna 1415, a memory 1425, code 1430, and a processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or memory components (for example, the processor 1435, or the memory 1425, or both), may be included in a chip or chip assembly that is installed in the device 1405. The transceiver 1410, or the transceiver 1410 and one or more antennas 1415 or wired interfaces, where applicable, may be an example of a transmitter 1115, a transmitter 1215, a receiver 1110, a receiver 1210, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1425 may include RAM and ROM. The memory 1425 may store computer-readable, computer-executable code 1430 including instructions that, when executed by the processor 1435, cause the device 1405 to perform various functions described herein. The code 1430 may be stored in a non-transitory computer-readable medium such as system memory or another type of memory. In some cases, the code 1430 may not be directly executable by the processor 1435 but may cause a computer (e.g., when compiled and executed) to perform functions described herein. In some cases, the memory 1425 may contain, among other things, a BIOS which may control basic hardware or software operation such as the interaction with peripheral components or devices.

The processor 1435 may include an intelligent hardware device (e.g., a general-purpose processor, a DSP, an ASIC, a CPU, a GPU, an FPGA, a microcontroller, a programmable logic device, discrete gate or transistor logic, a discrete hardware component, or any combination thereof). In some cases, the processor 1435 may be configured to operate a memory array using a memory controller. In some other cases, a memory controller may be integrated into the processor 1435. The processor 1435 may be configured to execute computer-readable instructions stored in a memory (e.g., the memory 1425) to cause the device 1405 to perform various functions (e.g., functions or tasks supporting reference signal resource selection based beam prediction). For example, the device 1405 or a component of the device 1405 may include a processor 1435 and memory 1425 coupled with the processor 1435, the processor 1435 and memory 1425 configured to perform various functions described herein. The processor 1435 may be an example of a cloud-computing platform (e.g., one or more physical nodes and supporting software such as operating systems, virtual machines, or container instances) that may host the functions (e.g., by executing code 1430) to perform the functions of the device 1405. The processor 1435 may be any one or more suitable processors capable of executing scripts or instructions of one or more software programs stored in the device 1405 (such as within the memory 1425). In some implementations, the processor 1435 may be a component of a processing system. A processing system may generally refer to a system or series of machines or components that receives inputs and processes the inputs to produce a set of outputs (which may be passed to other systems or components of, for example, the device 1405). For example, a processing system of the device 1405 may refer to a system including the various other components or subcomponents of the device 1405, such as the processor 1435, or the transceiver 1410, or the communications manager 1420, or other components or combinations of components of the device 1405. The processing system of the device 1405 may interface with other components of the device 1405, and may process information received from other components (such as inputs or signals) or output information to other components. For example, a chip or modem of the device 1405 may include a processing system and an interface to output information, or to obtain information, or both. The interface may be implemented as or otherwise include a first interface configured to output information and a second interface configured to obtain information. In some implementations, the first interface may refer to an interface between the processing system of the chip or modem and a transmitter, such that the device 1405 may transmit information output from the chip or modem. In some implementations, the second interface may refer to an interface between the processing system of the chip or modem and a receiver, such that the device 1405 may obtain information or signal inputs, and the information may be passed to the processing system. A person having ordinary skill in the art will readily recognize that the first interface also may obtain information or signal inputs, and the second interface also may output information or signal outputs.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the memory 1425, the code 1430, and the processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with other network entities 105, and may include a controller or scheduler for controlling communications with UEs 115 in cooperation with other network entities 105. In some examples, the communications manager 1420 may support an X2 interface within an LTE/LTE-A wireless communications network technology to provide communication between network entities 105.

The communications manager 1420 may support wireless communication at a network entity in accordance with examples as disclosed herein. For example, the communications manager 1420 may be configured as or otherwise support a means for transmitting a first message indicating a reference signal resource set including a set of multiple reference signal resources associated with a TDM scheme. The communications manager 1420 may be configured as or otherwise support a means for receiving a set of multiple reference signals using the set of multiple reference signal resources according to the TDM scheme. The communications manager 1420 may be configured as or otherwise support a means for transmitting a second message including a reference signal resource indicator indicating two or more reference signal resources of the set of multiple reference signal resources. The communications manager 1420 may be configured as or otherwise support a means for receiving a first uplink message using a first uplink transmission beam, the first uplink transmission beam based on a set of beams that correspond to the two or more reference signal resources.

By including or configuring the communications manager 1420 in accordance with examples as described herein, the device 1405 may support techniques for reference signal resource selection-based beam predictions, which may reduce power and overhead consumption for the device 1405. As such, the described techniques may support improved beam sweeping and SRI generation, among other benefits.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the processor 1435, the memory 1425, the code 1430, the transceiver 1410, or any combination thereof. For example, the code 1430 may include instructions executable by the processor 1435 to cause the device 1405 to perform various aspects of reference signal resource selection based beam prediction as described herein, or the processor 1435 and the memory 1425 may be otherwise configured to perform or support such operations.

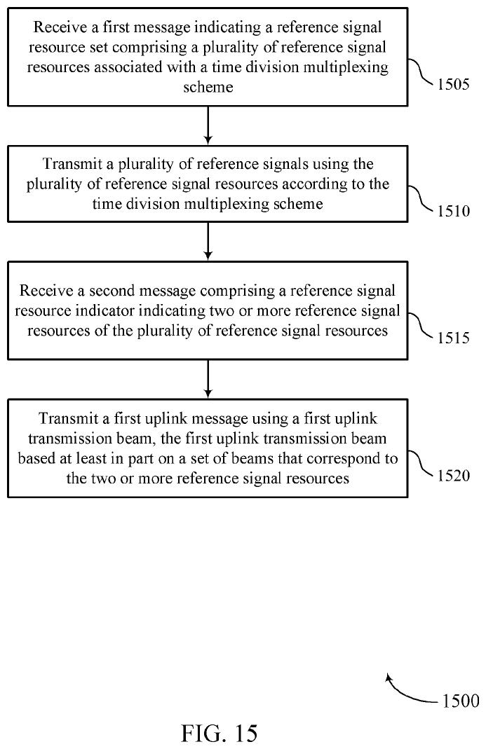

FIG. 15 shows a flowchart illustrating a method 1500 that supports reference signal resource selection based beam prediction in accordance with one or more aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include receiving a first message indicating a reference signal resource set comprising a plurality of reference signal resources associated with a TDM scheme. The operations of 1505 may be performed in accordance with examples as disclosed herein. In some examples, aspects of the operations of 1505 may be performed by a message component 925 as described with reference to FIG. 9.

At 1510, the method may include transmitting a plurality of reference signals using at least a portion of the plurality of reference signal resources according to the TDM scheme. The operations of 1510 may be performed in accordance with examples as disclosed herein. In some examples, aspects of the operations of 1510 may be performed by a reference signal component 930 as described with reference to FIG. 9.

At 1515, the method may include receiving a second message comprising a reference signal resource indicator indicating two or more reference signal resources of the plurality of reference signal resources. The operations of 1515 may be performed in accordance with examples as disclosed herein. In some examples, aspects of the operations of 1515 may be performed by an SRI component 935 as described with reference to FIG. 9.

At 1520, the method may include transmitting a first uplink message using a first uplink transmission beam, the first uplink transmission beam based at least in part on a set of beams that correspond to the two or more reference signal resources. The operations of 1520 may be performed in accordance with examples as disclosed herein. In some examples, aspects of the operations of 1520 may be performed by an uplink message component 940 as described with reference to FIG. 9.

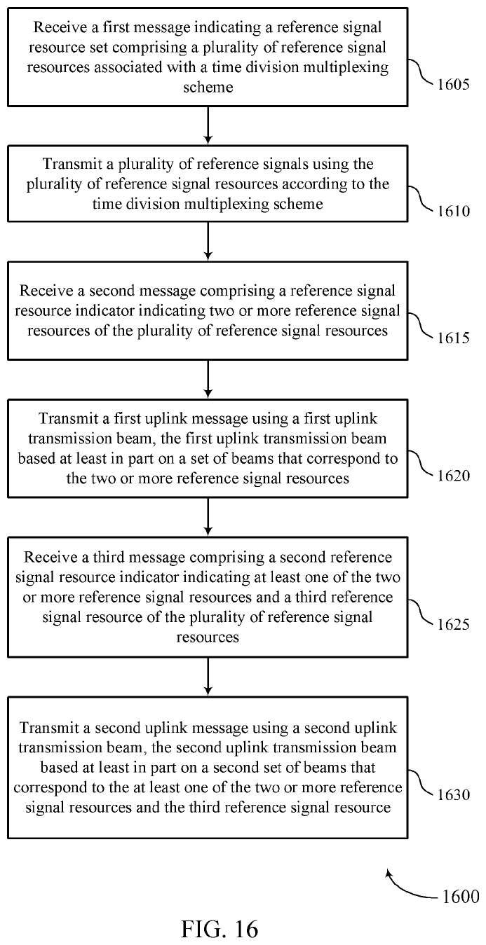

FIG. 16 shows a flowchart illustrating a method 1600 that supports reference signal resource selection based beam prediction in accordance with one or more aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1605, the method may include receiving a first message indicating a reference signal resource set comprising a plurality of reference signal resources associated with a TDM scheme. The operations of 1605 may be performed in accordance with examples as disclosed herein. In some examples, aspects of the operations of 1605 may be performed by a message component 925 as described with reference to FIG. 9.

At 1610, the method may include transmitting a plurality of reference signals using at least a portion of the plurality of reference signal resources according to the TDM scheme. The operations of 1610 may be performed in accordance with examples as disclosed herein. In some examples, aspects of the operations of 1610 may be performed by a reference signal component 930 as described with reference to FIG. 9.

At 1615, the method may include receiving a second message comprising a reference signal resource indicator indicating two or more reference signal resources of the plurality of reference signal resources. The operations of 1615 may be performed in accordance with examples as disclosed herein. In some examples, aspects of the operations of 1615 may be performed by an SRI component 935 as described with reference to FIG. 9.

At 1620, the method may include transmitting a first uplink message using a first uplink transmission beam, the first uplink transmission beam based at least in part on a set of beams that correspond to the two or more reference signal resources. The operations of 1620 may be performed in accordance with examples as disclosed herein. In some examples, aspects of the operations of 1620 may be performed by an uplink message component 940 as described with reference to FIG. 9.

At 1625, the method may include receiving a third message comprising a second reference signal resource indicator indicating at least one of the two or more reference signal resources and a third reference signal resource of the plurality of reference signal resources. The operations of 1625 may be performed in accordance with examples as disclosed herein. In some examples, aspects of the operations of 1625 may be performed by an SRI component 935 as described with reference to FIG. 9.

At 1630, the method may include transmitting a second uplink message using a second uplink transmission beam, the second uplink transmission beam based at least in part on a second set of beams that correspond to the at least one of the two or more reference signal resources and the third reference signal resource. The operations of 1630 may be performed in accordance with examples as disclosed herein. In some examples, aspects of the operations of 1630 may be performed by an uplink message component 940 as described with reference to FIG. 9.

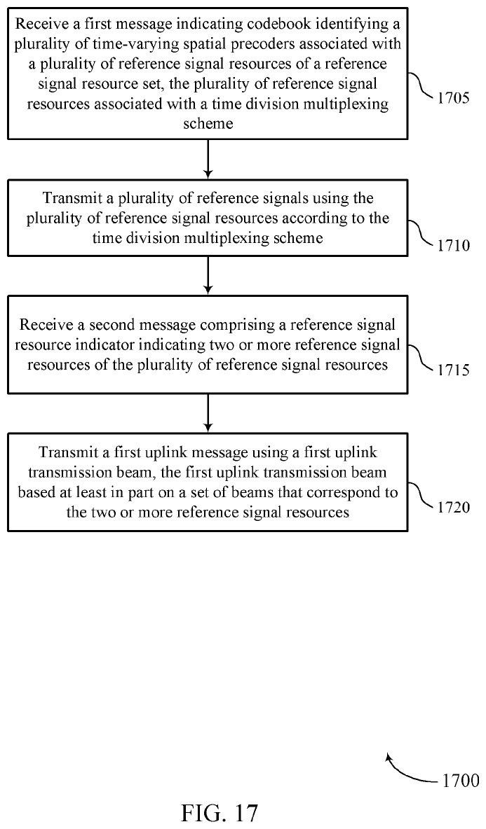

FIG. 17 shows a flowchart illustrating a method 1700 that supports reference signal resource selection based beam prediction in accordance with one or more aspects of the present disclosure. The operations of the method 1700 may be implemented by a UE or its components as described herein. For example, the operations of the method 1700 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1705, the method may include receiving a first message indicating codebook identifying a plurality of time-varying spatial precoders associated with a plurality of reference signal resources of a reference signal resource set, the set of reference signal resources associated with a TDM scheme. The operations of 1705 may be performed in accordance with examples as disclosed herein. In some examples, aspects of the operations of 1705 may be performed by a codebook component 950 as described with reference to FIG. 9.

At 1710, the method may include transmitting a plurality of reference signals using at least a portion of the plurality of reference signal resources according to the TDM scheme. The operations of 1710 may be performed in accordance with examples as disclosed herein. In some examples, aspects of the operations of 1710 may be performed by a reference signal component 930 as described with reference to FIG. 9.

At 1715, the method may include receiving a second message comprising a reference signal resource indicator indicating two or more reference signal resources of the plurality of reference signal resources. The operations of 1715 may be performed in accordance with examples as disclosed herein. In some examples, aspects of the operations of 1715 may be performed by an SRI component 935 as described with reference to FIG. 9.

At 1720, the method may include transmitting a first uplink message using a first uplink transmission beam, the first uplink transmission beam based at least in part on a set of beams that correspond to the two or more reference signal resources. The operations of 1720 may be performed in accordance with examples as disclosed herein. In some examples, aspects of the operations of 1720 may be performed by an uplink message component 940 as described with reference to FIG. 9.

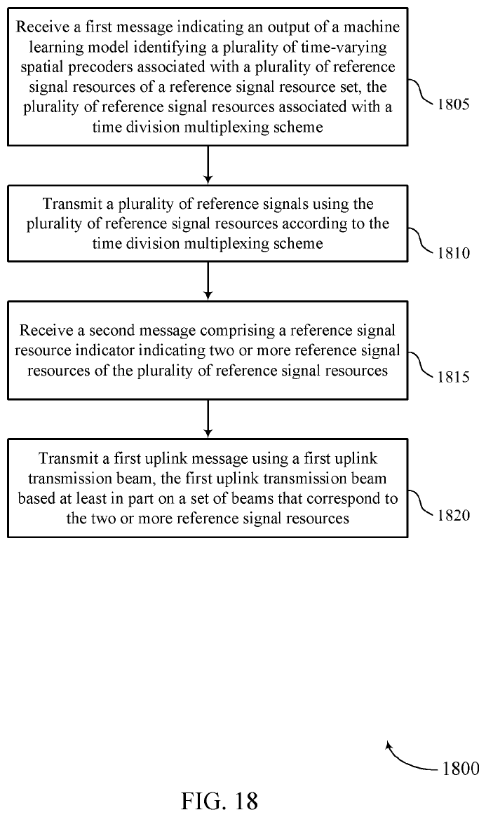

FIG. 18 shows a flowchart illustrating a method 1800 that supports reference signal resource selection based beam prediction in accordance with one or more aspects of the present disclosure. The operations of the method 1800 may be implemented by a UE or its components as described herein. For example, the operations of the method 1800 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1805, the method may include receiving a first message indicating an output of a machine learning model identifying a plurality of time-varying spatial precoders associated with a plurality of reference signal resources of a reference signal resource set, the plurality of reference signal resources associated with a TDM scheme. The operations of 1805 may be performed in accordance with examples as disclosed herein. In some examples, aspects of the operations of 1805 may be performed by an AI model component 955 as described with reference to FIG. 9.

At 1810, the method may include transmitting a plurality of reference signals using at least a portion of the plurality of reference signal resources according to the TDM scheme. The operations of 1810 may be performed in accordance with examples as disclosed herein. In some examples, aspects of the operations of 1810 may be performed by a reference signal component 930 as described with reference to FIG. 9.

At 1815, the method may include receiving a second message comprising a reference signal resource indicator indicating two or more reference signal resources of the plurality of reference signal resources. The operations of 1815 may be performed in accordance with examples as disclosed herein. In some examples, aspects of the operations of 1815 may be performed by an SRI component 935 as described with reference to FIG. 9.

At 1820, the method may include transmitting a first uplink message using a first uplink transmission beam, the first uplink transmission beam based at least in part on a set of beams that correspond to the two or more reference signal resources. The operations of 1820 may be performed in accordance with examples as disclosed herein. In some examples, aspects of the operations of 1820 may be performed by an uplink message component 940 as described with reference to FIG. 9.

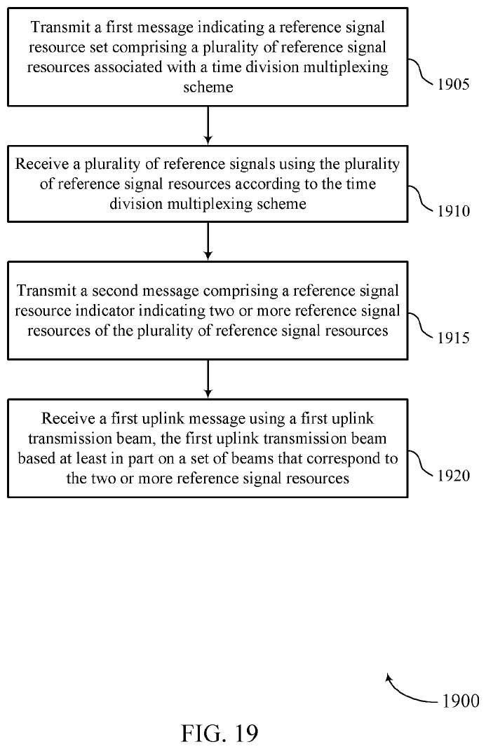

FIG. 19 shows a flowchart illustrating a method 1900 that supports reference signal resource selection based beam prediction in accordance with one or more aspects of the present disclosure. The operations of the method 1900 may be implemented by a network entity or its components as described herein. For example, the operations of the method 1900 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1905, the method may include transmitting a first message indicating a reference signal resource set comprising a plurality of reference signal resources associated with a TDM scheme. The operations of 1905 may be performed in accordance with examples as disclosed herein. In some examples, aspects of the operations of 1905 may be performed by a resource set component 1325 as described with reference to FIG. 13.

At 1910, the method may include receiving a plurality of reference signals using at least a portion of the plurality of reference signal resources according to the TDM scheme. The operations of 1910 may be performed in accordance with examples as disclosed herein. In some examples, aspects of the operations of 1910 may be performed by a reference signal reception component 1330 as described with reference to FIG. 13.

At 1915, the method may include transmitting a second message comprising a reference signal resource indicator indicating two or more reference signal resources of the plurality of reference signal resources. The operations of 1915 may be performed in accordance with examples as disclosed herein. In some examples, aspects of the operations of 1915 may be performed by an SRI transmission component 1335 as described with reference to FIG. 13.

At 1920, the method may include receiving a first uplink message using a first uplink transmission beam, the first uplink transmission beam based at least in part on a set of beams that correspond to the two or more reference signal resources. The operations of 1920 may be performed in accordance with examples as disclosed herein. In some examples, aspects of the operations of 1920 may be performed by an uplink message reception component 1340 as described with reference to FIG. 13.

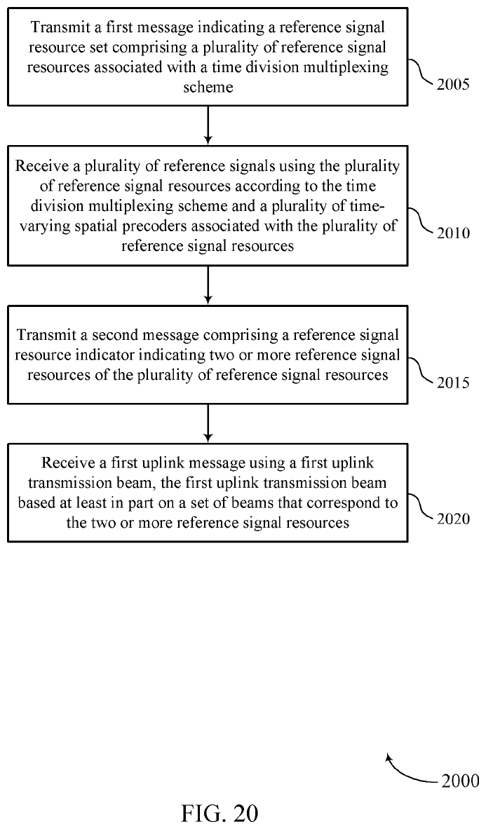

FIG. 20 shows a flowchart illustrating a method 2000 that supports reference signal resource selection based beam prediction in accordance with one or more aspects of the present disclosure. The operations of the method 2000 may be implemented by a network entity or its components as described herein. For example, the operations of the method 2000 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 2005, the method may include transmitting a first message indicating a reference signal resource set comprising a plurality of reference signal resources associated with a TDM scheme. The operations of 2005 may be performed in accordance with examples as disclosed herein. In some examples, aspects of the operations of 2005 may be performed by a resource set component 1325 as described with reference to FIG. 13.

At 2010, the method may include receiving a plurality of reference signals using at least a portion of the plurality of reference signal resources according to the TDM scheme and a plurality of time-varying spatial precoders associated with the plurality of reference signal resources. The operations of 2010 may be performed in accordance with examples as disclosed herein. In some examples, aspects of the operations of 2010 may be performed by a precoder component 1345 as described with reference to FIG. 13.

At 2015, the method may include transmitting a second message comprising a reference signal resource indicator indicating two or more reference signal resources of the plurality of reference signal resources. The operations of 2015 may be performed in accordance with examples as disclosed herein. In some examples, aspects of the operations of 2015 may be performed by an SRI transmission component 1335 as described with reference to FIG. 13.

At 2020, the method may include receiving a first uplink message using a first uplink transmission beam, the first uplink transmission beam based at least in part on a set of beams that correspond to the two or more reference signal resources. The operations of 2020 may be performed in accordance with examples as disclosed herein. In some examples, aspects of the operations of 2020 may be performed by an uplink message reception component 1340 as described with reference to FIG. 13.

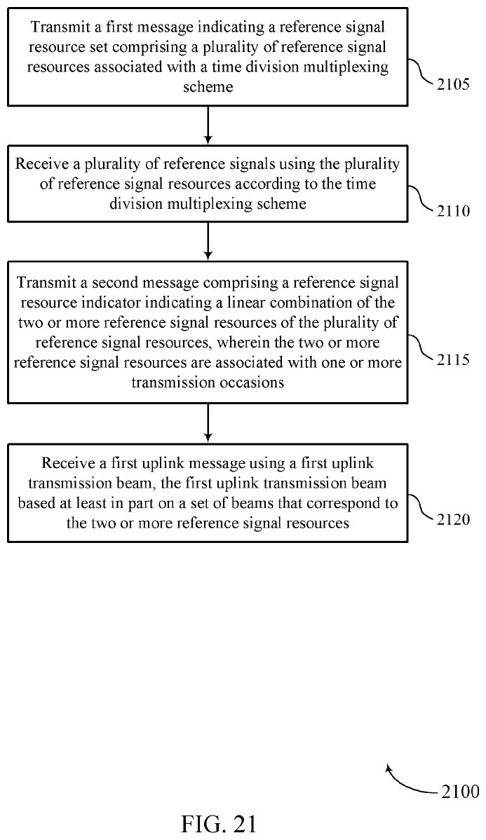

FIG. 21 shows a flowchart illustrating a method 2100 that supports reference signal resource selection based beam prediction in accordance with one or more aspects of the present disclosure. The operations of the method 2100 may be implemented by a network entity or its components as described herein. For example, the operations of the method 2100 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 2105, the method may include transmitting a first message indicating a reference signal resource set comprising a plurality of reference signal resources associated with a TDM scheme. The operations of 2105 may be performed in accordance with examples as disclosed herein. In some examples, aspects of the operations of 2105 may be performed by a resource set component 1325 as described with reference to FIG. 13.

At 2110, the method may include receiving a plurality of reference signals using at least a portion of the plurality of reference signal resources according to the TDM scheme. The operations of 2110 may be performed in accordance with examples as disclosed herein. In some examples, aspects of the operations of 2110 may be performed by a reference signal reception component 1330 as described with reference to FIG. 13.

At 2115, the method may include transmitting a second message comprising a reference signal resource indicator indicating a linear combination of the two or more reference signal resources of the plurality of reference signal resources, where the two or more reference signal resources are associated with one or more transmission occasions. The operations of 2115 may be performed in accordance with examples as disclosed herein. In some examples, aspects of the operations of 2115 may be performed by a linear combination component 1360 as described with reference to FIG. 13.

At 2120, the method may include receiving a first uplink message using a first uplink transmission beam, the first uplink transmission beam based at least in part on a set of beams that correspond to the two or more reference signal resources. The operations of 2120 may be performed in accordance with examples as disclosed herein. In some examples, aspects of the operations of 2120 may be performed by an uplink message reception component 1340 as described with reference to FIG. 13.

The following provides an overview of aspects of the present disclosure:

Aspect 1: A method for wireless communication at a UE, comprising: receiving a first message indicating a reference signal resource set comprising a plurality of reference signal resources associated with a TDM scheme; transmitting a plurality of reference signals using at least a portion of the plurality of reference signal resources according to the TDM scheme; receiving a second message comprising a reference signal resource indicator indicating two or more reference signal resources of the plurality of reference signal resources; and transmitting a first uplink message using a first uplink transmission beam, the first uplink transmission beam based at least in part on a set of beams that correspond to the two or more reference signal resources.

Aspect 2: The method of aspect 1, further comprising: receiving a third message comprising a second reference signal resource indicator indicating at least one of the two or more reference signal resources and a third reference signal resource of the plurality of reference signal resources; and transmitting a second uplink message using a second uplink transmission beam, the second uplink transmission beam based at least in part on a second set of beams that correspond to the at least one of the two or more reference signal resources and the third reference signal resource.

Aspect 3: The method of any of aspects 1 through 2, wherein transmitting the plurality of reference signals comprises: transmitting the plurality of reference signals using at least the portion of the plurality of reference signal resources according to the TDM scheme and a plurality of time-varying spatial precoders associated with the plurality of reference signal resources.

Aspect 4: The method of aspect 3, wherein the plurality of time-varying spatial precoders are different for different transmission occasions of the plurality of reference signals; and the plurality of reference signals are transmitted according to a periodicity or semi-persistently.

Aspect 5: The method of any of aspects 1 through 4, wherein receiving the first message comprises: receiving the first message indicating codebook identifying a plurality of time-varying spatial precoders associated with the plurality of reference signal resources of the reference signal resource set.

Aspect 6: The method of aspect 5, wherein the codebook is time-variant based at least in part on an indication from a network entity or the UE.

Aspect 7: The method of any of aspects 1 through 6, wherein receiving the first message comprises: receiving the first message indicating an output of a machine learning model identifying a plurality of time-varying spatial precoders associated with the plurality of reference signal resources of the reference signal resource set.

Aspect 8: The method of aspect 7, wherein the machine learning model is time-variant based at least in part on an indication from a network entity or the UE.

Aspect 9: The method of any of aspects 1 through 8, wherein receiving the second message comprises: receiving the second message comprising the reference signal resource indicator indicating a linear combination of the two or more reference signal resources of the plurality of reference signal resources, wherein the two or more reference signal resources are associated with one or more transmission occasions.

Aspect 10: The method of aspect 9, wherein transmitting the first uplink message comprises: transmitting the first uplink message based at least in part on a spatial precoder associated with the linear combination of the two or more reference signal resources.

Aspect 11: The method of any of aspects 1 through 10, wherein transmitting the first uplink message comprises: transmitting the first uplink message based at least in part on a spatial precoder output by a machine learning model, wherein the machine learning model uses at least the reference signal resource indicator as an input.

Aspect 12: The method of any of aspects 1 through 11, wherein receiving the second message comprises: receiving the second message comprising the reference signal resource indicator indicating the two or more reference signal resources and comprising a rank of the reference signal resource indicator.

Aspect 13: The method of aspect 12, wherein transmitting the first uplink message comprises: transmitting the first uplink message based at least in part on a spatial precoder associated with the rank of the reference signal resource indicator, where the spatial precoder is used with different reference signal ports.

Aspect 14: The method of any of aspects 1 through 13, wherein receiving the first message comprises: receiving the first message indicating a usage type associated with the reference signal resource set comprising the plurality of reference signal resources.

Aspect 15: The method of any of aspects 1 through 14, wherein receiving the second message comprises: receiving the second message comprising the reference signal resource indicator, wherein the second message configures an uplink transmission configuration indicator state for the UE.

Aspect 16: A method for wireless communication at a network entity, comprising: transmitting a first message indicating a reference signal resource set comprising a plurality of reference signal resources associated with a TDM scheme; receiving a plurality of reference signals using at least a portion of the plurality of reference signal resources according to the TDM scheme; transmitting a second message comprising a reference signal resource indicator indicating two or more reference signal resources of the plurality of reference signal resources; and receiving a first uplink message using a first uplink transmission beam, the first uplink transmission beam based at least in part on a set of beams that correspond to the two or more reference signal resources.

Aspect 17: The method of aspect 16, further comprising: transmitting a third message comprising a second reference signal resource indicator indicating at least one of the two or more reference signal resources and a third reference signal resource of the plurality of reference signal resources; and receiving a second uplink message using a second uplink transmission beam, the second uplink transmission beam based at least in part on a second set of beams that correspond to the at least one of the two or more reference signal resources and the third reference signal resource.

Aspect 18: The method of any of aspects 16 through 17, wherein receiving the plurality of reference signals comprises: receiving the plurality of reference signals using at least the portion of the plurality of reference signal resources according to the TDM scheme and a plurality of time-varying spatial precoders associated with the plurality of reference signal resources.

Aspect 19: The method of aspect 18, wherein the plurality of time-varying spatial precoders are different for different transmission occasions of the plurality of reference signals, wherein the plurality of reference signals are transmitted according to a periodicity or semi-persistently.

Aspect 20: The method of any of aspects 16 through 19, wherein transmitting the first message comprises: transmitting the first message indicating codebook identifying a plurality of time-varying spatial precoders associated with the plurality of reference signal resources of the reference signal resource set.

Aspect 21: The method of aspect 20, wherein the codebook is time-variant based at least in part on an indication from the network entity or a UE.

Aspect 22: The method of any of aspects 16 through 21, wherein transmitting the first message comprises: transmitting the first message indicating an output of a machine learning model identifying a plurality of time-varying spatial precoders associated with the plurality of reference signal resources of the reference signal resource set.

Aspect 23: The method of aspect 22, wherein the machine learning model is time-variant based at least in part on an indication from the network entity or a UE.

Aspect 24: The method of any of aspects 16 through 23, wherein transmitting the second message comprises: transmitting the second message comprising the reference signal resource indicator indicating a linear combination of the two or more reference signal resources of the plurality of reference signal resources, wherein the two or more reference signal resources are associated with one or more transmission occasions.

Aspect 25: The method of any of aspects 16 through 24, wherein transmitting the second message comprises: transmitting the second message comprising the reference signal resource indicator indicating the two or more reference signal resources and comprising a rank of the reference signal resource indicator.

Aspect 26: The method of any of aspects 16 through 25, wherein transmitting the first message comprises: transmitting the first message indicating a usage type associated with the reference signal resource set comprising the plurality of reference signal resources.

Aspect 27: The method of any of aspects 16 through 26, wherein transmitting the second message comprises: transmitting the second message comprising the reference signal resource indicator, wherein the second message configures an uplink transmission configuration indicator state for a UE.

Aspect 28: An apparatus for wireless communication at a UE, comprising at least one processor; and memory coupled with the at least one processor, the memory storing instructions executable by the at least one processor to cause the UE to perform a method of any of aspects 1 through 15.

Aspect 29: An apparatus for wireless communication at a UE, comprising at least one means for performing a method of any of aspects 1 through 15.

Aspect 30: A non-transitory computer-readable medium storing code for wireless communication at a UE, the code comprising instructions executable by at least one processor to perform a method of any of aspects 1 through 15.

Aspect 31: An apparatus for wireless communication at a network entity, comprising at least one processor; and memory coupled with the at least one processor, the memory storing instructions executable by the at least one processor to cause the network entity to perform a method of any of aspects 16 through 27.

Aspect 32: An apparatus for wireless communication at a network entity, comprising at least one means for performing a method of any of aspects 16 through 27.

Aspect 33: A non-transitory computer-readable medium storing code for wireless communication at a network entity, the code comprising instructions executable by at least one processor to perform a method of any of aspects 16 through 27.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), IEEE 802.11 (Wi-Fi), IEEE 802.16 (WiMAX), IEEE 802.20, Flash-OFDM, as well as other systems and radio technologies, including future systems and radio technologies, not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a GPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (e.g., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
receiving a first message indicating a reference signal resource set comprising a plurality of reference signal resources associated with a time division multiplexing scheme;
transmitting a plurality of reference signals using at least a portion of the plurality of reference signal resources according to the time division multiplexing scheme;
receiving a second message comprising a reference signal resource indicator indicating two or more reference signal resources of the plurality of reference signal resources; and
transmitting a first uplink message using a first uplink transmission beam, the first uplink transmission beam based at least in part on a set of beams that correspond to the two or more reference signal resources.

2. The method of claim 1, further comprising:
receiving a third message comprising a second reference signal resource indicator indicating at least one of the two or more reference signal resources and a third reference signal resource of the plurality of reference signal resources; and
transmitting a second uplink message using a second uplink transmission beam, the second uplink transmission beam based at least in part on a second set of beams that correspond to the at least one of the two or more reference signal resources and the third reference signal resource.

3. The method of claim 1, wherein transmitting the plurality of reference signals comprises:
transmitting the plurality of reference signals using at least the portion of the plurality of reference signal resources according to the time division multiplexing scheme and a plurality of time-varying spatial precoders associated with the plurality of reference signal resources.

4. The method of claim 3, wherein:
the plurality of time-varying spatial precoders are different for different transmission occasions of the plurality of reference signals; and
the plurality of reference signals are transmitted according to a periodicity or semi-persistently.

5. The method of claim 1, wherein receiving the first message comprises:
receiving the first message indicating codebook identifying a plurality of time-varying spatial precoders associated with the plurality of reference signal resources of the reference signal resource set.

6. The method of claim 5, wherein the codebook is time-variant based at least in part on an indication from a network entity or the UE.

7. The method of claim 1, wherein receiving the first message comprises:
receiving the first message indicating an output of a machine learning model identifying a plurality of time-varying spatial precoders associated with the plurality of reference signal resources of the reference signal resource set.

8. The method of claim 7, wherein the machine learning model is time-variant based at least in part on an indication from a network entity or the UE.

9. The method of claim 1, wherein receiving the second message comprises:
receiving the second message comprising the reference signal resource indicator indicating a linear combination of the two or more reference signal resources of the plurality of reference signal resources, wherein the two or more reference signal resources are associated with one or more transmission occasions.

10. The method of claim 9, wherein transmitting the first uplink message comprises:
transmitting the first uplink message based at least in part on a spatial precoder associated with the linear combination of the two or more reference signal resources.

11. The method of claim 1, wherein transmitting the first uplink message comprises:
transmitting the first uplink message based at least in part on a spatial precoder output by a machine learning model, wherein the machine learning model uses at least the reference signal resource indicator as an input.

12. The method of claim 1, wherein receiving the second message comprises:
receiving the second message comprising the reference signal resource indicator indicating the two or more reference signal resources and comprising a rank of the reference signal resource indicator.

13. The method of claim 12, wherein transmitting the first uplink message comprises:
transmitting the first uplink message based at least in part on a spatial precoder associated with the rank of the reference signal resource indicator, where the spatial precoder is used with different reference signal ports.

14. The method of claim 1, wherein receiving the first message comprises:
receiving the first message indicating a usage type associated with the reference signal resource set comprising the plurality of reference signal resources.

15. The method of claim 1, wherein receiving the second message comprises:
receiving the second message comprising the reference signal resource indicator, wherein the second message configures an uplink transmission configuration indicator state for the UE.

16. A method for wireless communication at a network entity, comprising:
transmitting a first message indicating a reference signal resource set comprising a plurality of reference signal resources associated with a time division multiplexing scheme;
receiving a plurality of reference signals using at least a portion of the plurality of reference signal resources according to the time division multiplexing scheme;
transmitting a second message comprising a reference signal resource indicator indicating two or more reference signal resources of the plurality of reference signal resources; and
receiving a first uplink message using a first uplink transmission beam, the first uplink transmission beam based at least in part on a set of beams that correspond to the two or more reference signal resources.

17. The method of claim 16, further comprising:
transmitting a third message comprising a second reference signal resource indicator indicating at least one of the two or more reference signal resources and a third reference signal resource of the plurality of reference signal resources; and
receiving a second uplink message using a second uplink transmission beam, the second uplink transmission beam based at least in part on a second set of beams that correspond to the at least one of the two or more reference signal resources and the third reference signal resource.

18. The method of claim 16, wherein receiving the plurality of reference signals comprises:
receiving the plurality of reference signals using at least the portion of the plurality of reference signal resources according to the time division multiplexing scheme and a plurality of time-varying spatial precoders associated with the plurality of reference signal resources.

19. The method of claim 18, wherein the plurality of time-varying spatial precoders are different for different transmission occasions of the plurality of reference signals, wherein the plurality of reference signals are transmitted according to a periodicity or semi-persistently.

20. The method of claim 16, wherein transmitting the first message comprises:
transmitting the first message indicating codebook identifying a plurality of time-varying spatial precoders associated with the plurality of reference signal resources of the reference signal resource set.

21. The method of claim 20, wherein the codebook is time-variant based at least in part on an indication from the network entity or a user equipment (UE).

22. The method of claim 16, wherein transmitting the first message comprises:
transmitting the first message indicating an output of a machine learning model identifying a plurality of time-varying spatial precoders associated with the plurality of reference signal resources of the reference signal resource set.

23. The method of claim 22, wherein the machine learning model is time-variant based at least in part on an indication from the network entity or a UE.

24. The method of claim 16, wherein transmitting the second message comprises:
transmitting the second message comprising the reference signal resource indicator indicating a linear combination of the two or more reference signal resources of the plurality of reference signal resources, wherein the two or more reference signal resources are associated with one or more transmission occasions.

25. The method of claim 16, wherein transmitting the second message comprises:
transmitting the second message comprising the reference signal resource indicator indicating the two or more reference signal resources and comprising a rank of the reference signal resource indicator.

26. The method of claim 16, wherein transmitting the first message comprises:
transmitting the first message indicating a usage type associated with the reference signal resource set comprising the plurality of reference signal resources.

27. The method of claim 16, wherein transmitting the second message comprises:
transmitting the second message comprising the reference signal resource indicator, wherein the second message configures an uplink transmission configuration indicator state for a UE.

28. An apparatus for wireless communication at a user equipment (UE), comprising:
at least one processor; and
memory coupled with the at least one processor, the memory storing instructions executable by the at least one processor to cause the UE to:
receive a first message indicating a reference signal resource set comprising a plurality of reference signal resources associated with a time division multiplexing scheme;
transmit a plurality of reference signals using at least a portion of the plurality of reference signal resources according to the time division multiplexing scheme;
receive a second message comprising a reference signal resource indicator indicating two or more reference signal resources of the plurality of reference signal resources; and
transmit a first uplink message using a first uplink transmission beam, the first uplink transmission beam based at least in part on a set of beams that correspond to the two or more reference signal resources.

29. The apparatus of claim 28, wherein the instructions are further executable by the at least one processor to cause the apparatus to:
receive a third message comprising a second reference signal resource indicator indicating at least one of the two or more reference signal resources and a third reference signal resource of the plurality of reference signal resources; and
transmit a second uplink message using a second uplink transmission beam, the second uplink transmission beam based at least in part on a second set of beams that correspond to the at least one of the two or more reference signal resources and the third reference signal resource.

30. An apparatus for wireless communication at a network entity, comprising:
at least one processor; and
memory coupled with the at least one processor, the memory storing instructions executable by the at least one processor to cause the network entity to:
transmit a first message indicating a reference signal resource set comprising a plurality of reference signal resources associated with a time division multiplexing scheme;
receive a plurality of reference signals using at least a portion of the plurality of reference signal resources according to the time division multiplexing scheme;
transmit a second message comprising a reference signal resource indicator indicating two or more reference signal resources of the plurality of reference signal resources; and
receive a first uplink message using a first uplink transmission beam, the first uplink transmission beam based at least in part on a set of beams that correspond to the two or more reference signal resources.
